(19) United States
(12) Patent Application Publication
(10) Pub. No.: US 2025/0357711 A1
(43) Pub. Date: Nov. 20, 2025

(54) TOOLLESS TERMINATION MODULAR CONNECTOR PLUG

(71) Applicant: Speaker Snap LLC, Fishers, IN (US)

(72) Inventor: Richard H. Goren, Fishers, IN (US)

(73) Assignee: Speaker Snap LLC, Fishers, IN (US)

(21) Appl. No.: 18/663,307

(22) Filed: May 14, 2024

(51) Int. Cl. H01R 24/64; H01R 13/424; H01R 13/506; H01R 13/58; H01R 13/627; H01R 43/048; H01R 107/00

(52) U.S. Cl. CPC H01R 24/64; H01R 13/424; H01R 13/506; H01R 13/5829; H01R 43/048; H01R 13/6272; H01R 2107/00; H01R 2201/04

(57) ABSTRACT

A modular connector plug configured to toollessly attach to a cable. The connector plug is formed from a plug body that includes a base and a cover. The base and the cover are coupled through a hinge. The hinge allows the base and the cover to rotate. When a cable is positioned in the base, the connector plug clamps onto the cable by rotating the cover about the hinge. The cover includes contacts that are configured to couple to wires within the cable. The connector plug supports multiple arrangements of wires within the plug body.

### BACKGROUND

Connectors can be used in a variety of settings to couple a cable to a port, jack, outlet, and/or another type of terminal. Some connectors electrically couple multiple wires in a cable to multiple pins and/or contact pads in a terminal. For example, a connector can attach to an ethernet or phone cable that includes multiple distinct conductors. Connectors allow a user to connect multiple devices over the cable, such as a connection between one or more phones, modems, routers, computers, and/or other devices. To ensure that the devices operate properly, the connector must reliably attach to all the wires in the cable. Ensuring that the connector fully attaches to the cable can be time consuming. Further, sometimes the connector does not sufficiently attach to all the wires and a user may have to reattach the connector to all the wires. Reattaching the cable in this way can waste even more time of the user.

Thus, there is a need for improvement in this field.

### SUMMARY

Various types of connectors are typically used to terminate wires and/or cables. Generally, the connectors are pluggable to allow a user to connect and disconnect the cable from a socket and/or jack. In some examples, connectors are used to connect a cable to an ethernet port on a device, such as a modem, router, computer, network switch, or another device. Many connectors require additional tools to attach a connector to a cable, such as a crimper and/or another tool. Some connectors require a user to unscrew and/or disassemble portions of the connector to be able to attach the connector to a cable. Complicated connector disassembly is typically time consuming and introduces multiple opportunities to incorrectly attach the connector. Further, requiring additional tools to attach the connector is generally time consuming and inconvenient. Such connectors may force a user to spend large amounts of time making custom cables, such as in information technology (IT) infrastructures, home cable installations, and/or wired computer networks as examples.

A unique toolless modular connector plug has been developed to attach to a cable in a quick and reliable way. In one example, the modular connector plug is a Registered Jack (RJ) 45 plug. In other examples, the modular connector plug is an RJ11 plug and/or another plug with multiple electrical contacts. In such examples, the cable includes multiple wires, such as in a Category 6, Category 5, Category 3, and/or another type of cable. Rather than requiring a user to shove the cable into a connector or to unscrew parts of a connector to receive the cable, the toolless modular connector plug is able to open to receive the cable. The modular connector plug is configured to attach to the cable by rotating into a closed position. Once the modular connector plug is attached to the cable, the modular connector plug allows a user to plug the modular connector plug and cable into a socket. The socket typically includes multiple pins that correspond to the wires in the cable. The modular connector plug includes multiple contacts that are configured to connect the wires and the pins when plugging in the modular connector plug. The modular connector plug allows a user to arrange wires in the plug according to a variety of standards. For example, a user can arrange the wires according to T568A and/or T568B conductor assignments as defined in ANSI/TIA-568. The modular connector plug is versatile and supports a variety of connection schemes. In the closed position, the modular connector plug clamps the cable in place and electrically connects the wires to the contacts. In this way, the modular connector plug allows a user to attach the cable to the modular connector plug in a single motion. The contacts automatically contact the conductive portion of the wires when closing the modular connector plug. By automatically connecting the wires to the contacts, the modular connector plug allows the user to attach the modular connector plug without a crimper or another tool.

The modular connector plug includes a plug body that forms the shape and structure of the modular connector plug. The plug body is generally rectangular in shape and typically shaped to insert into a socket in only one orientation. The box shape of the plug body generally complements the shape of the socket. Further, the size of the plug body is generally similar to the size of the cable. For example, a cross-sectional area of the plug body is on the same order of magnitude as a cross-sectional area of the cable. Using a plug body with this size supports a compact form for the modular connector plug. The combination of the compact shape and relatively simple rectangular shape enables the modular connector plug to fit in a variety of locations and to be used in many different settings. The plug body includes a base and a cover. The base and the cover are coupled together at a hinge. The hinge enables the base and the cover to rotate relative to one another. In the open position, the base and the cover are rotated away from each other. Conversely, the base and the cover are rotated towards and fixed against each other in the closed position. The cover and the base define a cavity that is configured to receive the cable. In one example, only a sheath of the cable is positioned in the cavity when the modular connector plug attaches to the cable. To attach the modular connector plug to the cable, the base typically allows a user to slide the cable in position along the base. With the cable in position against the base, the modular connector plug clamps onto the cable by rotating the cover into the closed position. The base generally aligns the wires of the cable with the contacts.

In one example, the plug body includes a head and a receptacle. The base and the cover each form portions of the head and the receptacle. The head is shaped to insert into a socket on a device. The receptacle generally provides an area for the user to grasp the modular connector plug. Further, the receptacle provides a larger space than the head to receive the cable. For example, the sheath of the cable is positioned within the receptacle but not within the head when the modular connector plug is attached to the cable. The individual wires are typically positioned within the head. The contacts are positioned at the head to be able to contact to the pins in the socket.

The base includes spacers that are positioned near the head. The spacers are configured to align the wires as a user slides the wires along the base. Between the spacers, the base defines multiple wire grooves. The wire grooves provide space for the wires to slide along and rest as the user positions the cable against the base. The spacers include tips that extend from one end. The tips are angled to a point so as to guide the wires into the grooves as a user slides the cable along the base. Further, the base includes base walls that are positioned on both lateral sides of the base. The base walls define a portion of the cavity configured to receive the cable.

The cover defines multiple slots at the head. The contacts are positioned within the slots. The cover includes multiple dividers that physically separate and electrically isolate the contacts. The dividers define contact grooves that generally align with the wire grooves on the base. The contact grooves provide space for the contacts. When the cable is coupled to the modular connector plug, the contact grooves receive portions of the wires. The dividers help to align the wires with the contacts as a user closes the modular connector plug. The cover further includes cover walls that extend along the lateral sides of the cover.

When the cover and the base close together, the spacers on the base and the dividers on the cover align. The spacers and the dividers collectively form multiple channels that provide space for the wires. The contacts generally extend partially into the channels. The wires are positioned within the channels when the modular connector plug attaches to the cable. In one form, the parts of the contacts that connect to the wires are sharpened to pierce through any insulation surrounding the wires and/or partially pierce into the wires to ensure firm electrical connections. Since the contacts extend into the channels, the contacts extend partially into the wires when coupled. By stabbing into the wires, the contacts ensure that the wires are secured in place and that the contacts electrically contact the conductors in the wires. Therefore, a user does not need to strip the individual wires before coupling the modular connector plug to the cable, if so desired. In other examples, the ends of the individual wires are stripped. Further, the base and the cover include one or more ridges. The ridges extend into the cavity at within the receptacle. The ridges generally compress the cable to secure the cable within the plug body. In one example, the ridges secure the sheath of the cable within the plug body so as to provide strain relief for the wires.

The base and the cover are configured to couple together in a variety of ways. In one example, the modular connector plug includes a snap-fit joint between the base and the cover. In one version, the base includes tabs on the base walls and the cover defines tab openings on the cover walls. The tabs secure the base to the cover when the modular connector plug is closed. Using such a snap-fit joint allows the base and the cover to fix to one another using a single pushing motion. In another version, the base includes leaves that define pin openings. The cover includes pivot pins. The pivot pins are chamfered on one end to allow the pivot pins to slide between the leaves and into the pin openings. The pivot pins and the pin openings secure the base to the cover and form the hinge between the base and the cover. In another example, various parts of the modular connector plug interact to form tongue and groove joints. The tongue and groove joints facilitate aligning the base and the cover and reinforcing the structure of the modular connector plug. In one version, the base includes ledges near the hinge and the cover defines notches configured to receive the ledges. The ledges and the notches help to align the base and the cover as the modular connector plug closes. In another version, the cover walls slide around the base walls to align the cover and the base. In yet another version, the base walls include humps that extend from the walls. The humps extend into a recess on the cover when the modular connector plug closes.

At the hinge, the base includes a cam surface that supports the cover during rotation. The cam surface is a smooth and round surface. The cover slides along the cam surface during rotation about the hinge. Further, the cover defines a rounded surface near the contacts. The rounded surface provides clearance for the base during rotation. In one example, the rounded surface on the cover supports the base during rotation. In another example, the leaves have rounded corners to avoid inhibiting rotation of the cover about the hinge. The base further includes a stopper on one end of the spacers. The stopper prevents wires from extending into the hinge and obstructing rotation.

The modular connector plug further includes a restraint coupled to the base. The restraint is configured to push the wires against the base before closing the modular connector plug. For example, the restraint holds the wires within the wire grooves between the spacers. Forming the restraint as a separate piece from the base facilitates manufacturing. For example, injection molding the restraint and the base as separate pieces is more reliable and reduces the risk of deformation compared to manufacturing a single combined part. In one version, the restraint includes pins and the base includes slots that receive the pins. The restraint is configured to rotate about the pins relative to the base. In another version, the restraint couples to the base through a snap-fit joint. For instance, the restraint includes flanges that extend outward. The base walls define flange openings that receive the flanges. Further, the base walls define tracks that guide the flanges into the flange openings as the restraint couples to the base. In one example, the snap-fit connection between the restraint and the base facilitates assembly of the modular connector plug. Generally, the restraint and the base define a gap. The gap provides a space for the user to slide the wires along the base and into the wire grooves.

The contacts generally include prongs that facilitate coupling the contacts to the wires. The prongs extend into the channels and are configured to press into the wires. In one example, the prongs include edges. The edges are sharpened, pointed, and/or otherwise configured to cut through insulation on the wires and to contact the conductor in the wires. In one version, the prongs are bent out of a plane extending across the contact. For instance, adjacent prongs are bent toward opposing directions away from the plane of the contact. By alternating the directions of the bends, the prongs apply tension on the wire to secure the wire against the contact. In this way, the contacts are configured to secure the wire in place and establish an electrical connection. For example, rotating the cover toward the base enables the cover to function as a lever with respect to the contacts. The user magnifies the force applied by the contacts onto the wires by rotating the cover from an opposite end. With the contacts being located on the cover proximal to where the pivot pins pivotally connect the cover to the base, the cover acts a class 2 lever during closure that facilitates crimping between the wires and the contacts. The modular connector plug reliably electrically connects each wire to the corresponding contact by clamping the contacts into the wires.

The systems and techniques as described and illustrated herein concern a number of unique and inventive aspects. Some, but by no means all, of these unique aspects are summarized below.
Aspect 1 generally concerns a system.
Aspect 2 generally concerns the system of any previous aspect including a modular connector plug.
Aspect 3 generally concerns the system of any previous aspect including a modular connector plug configured to clamp to a cable.
Aspect 4 generally concerns the system of any previous aspect including a cable including one or more wires.
Aspect 5 generally concerns the system of any previous aspect including a wire having a conductor.
Aspect 6 generally concerns the system of any previous aspect including a wire having insulation surrounding the conductor.
Aspect 7 generally concerns the system of any previous aspect in which the cable is a Category 6 cable.
Aspect 8 generally concerns the system of any previous aspect in which the cable includes eight wires.
Aspect 9 generally concerns the system of any previous aspect including a modular connector plug configured to couple to the cable.
Aspect 10 generally concerns the system of any previous aspect in which the modular connector plug is an RJ45 plug.
Aspect 11 generally concerns the system of any previous aspect in which the modular connector plug is pluggable into a socket.
Aspect 12 generally concerns the system of any previous aspect including a socket including one or more contacts.
Aspect 13 generally concerns the system of any previous aspect including a modular connector plug configured to electrically connect the wires to the contacts in the socket.
Aspect 14 generally concerns the system of any previous aspect including a plug body including a base and a cover.
Aspect 15 generally concerns the system of any previous aspect including a base configured to rotate relative to the cover.
Aspect 16 generally concerns the system of any previous aspect in which the base and the cover are coupled via a hinge.
Aspect 17 generally concerns the system of any previous aspect in which the base is free to rotate relative to the cover about the hinge.
Aspect 18 generally concerns the system of any previous aspect including a cover including one or more contacts.
Aspect 19 generally concerns the system of any previous aspect including contacts configured to electrically connect to the wires.
Aspect 20 generally concerns the system of any previous aspect including a contact including one or more prongs.
Aspect 21 generally concerns the system of any previous aspect in which each prong includes an edge.
Aspect 22 generally concerns the system of any previous aspect including an edge configured to pierce insulation on the wires.
Aspect 23 generally concerns the system of any previous aspect including prongs configured to stab the wire.
Aspect 24 generally concerns the system of any previous aspect in which the prongs are bent out of a plane defined by the contact.
Aspect 25 generally concerns the system of any previous aspect in which the contact includes three prongs.
Aspect 26 generally concerns the system of any previous aspect in which the contact is configured to electrically connect to the wire through the prongs.
Aspect 27 generally concerns the system of any previous aspect in which the prongs are configured to contact the conductor in the wire.
Aspect 28 generally concerns the system of any previous aspect in which the cover defines slots.
Aspect 29 generally concerns the system of any previous aspect in which the contact is positioned in one slot.
Aspect 30 generally concerns the system of any previous aspect including a cover including one or more dividers.
Aspect 31 generally concerns the system of any previous aspect in which the dividers electrically insulate the contacts from one another.
Aspect 32 generally concerns the system of any previous aspect in which the dividers include pads.
Aspect 33 generally concerns the system of any previous aspect in which the pads touch the contacts within the slots.
Aspect 34 generally concerns the system of any previous aspect in which the pads inhibit movement of the contacts within the slots.
Aspect 35 generally concerns the system of any previous aspect in which the dividers and the spacers define channels when the connector is in the closed position.
Aspect 36 generally concerns the system of any previous aspect in which the channels are configured to receive the wires.
Aspect 37 generally concerns the system of any previous aspect in which the contacts extend into the channels.
Aspect 38 generally concerns the system of any previous aspect in which the contacts are configured to wedge into the wires within the channel.
Aspect 39 generally concerns the system of any previous aspect in which the cover includes a brace.
Aspect 40 generally concerns the system of any previous aspect in which the contact defines a divot.
Aspect 41 generally concerns the system of any previous aspect in which the brace is positioned in the divot.
Aspect 42 generally concerns the system of any previous aspect in which the brace secures the contact in the slot in the plug body.
Aspect 43 generally concerns the system of any previous aspect in which the contact couples to the wire when the connector closes around the cable.
Aspect 44 generally concerns the system of any previous aspect in which the contacts in the modular connector plug are configured to touch contacts in the socket.
Aspect 45 generally concerns the system of any previous aspect including a base defining a cavity.
Aspect 46 generally concerns the system of any previous aspect including a restraint coupled to the base.
Aspect 47 generally concerns the system of any previous aspect including a restraint configured to hold the wires against the base.
Aspect 48 generally concerns the system of any previous aspect in which the base and the restraint define a gap.
Aspect 49 generally concerns the system of any previous aspect in which the gap is configured to receive the wires as the wires slide along the base.
Aspect 50 generally concerns the system of any previous aspect in which the connector allows a user to slide wires into the gap.
Aspect 51 generally concerns the system of any previous aspect in which the restraint includes one or more flanges.
Aspect 52 generally concerns the system of any previous aspect in which the base defines one or more flange openings.
Aspect 53 generally concerns the system of any previous aspect in which the base defines tracks that extend toward the flange openings.
Aspect 54 generally concerns the system of any previous aspect in which the tracks are configured to guide the flanges into the flange openings.
Aspect 55 generally concerns the system of any previous aspect in which the flanges are positioned in the flange openings.
Aspect 56 generally concerns the system of any previous aspect in which the flanges secure the restraint against the base.
Aspect 57 generally concerns the system of any previous aspect in which the restraint attaches to the base through a snap-fit joint.
Aspect 58 generally concerns the system of any previous aspect in which the restraint is configured to rotate relative to the base.
Aspect 59 generally concerns the system of any previous aspect in which the restraint

includes one or more pegs.
Aspect 60 generally concerns the system of any previous aspect in which the base defines peg slots.
Aspect 61 generally concerns the system of any previous aspect in which the pegs are positioned within the peg slots.
Aspect 62 generally concerns the system of any previous aspect in which the pegs and peg slots support the restraint to rotate relative to the base.
Aspect 63 generally concerns the system of any previous aspect in which the restraint is fixed against the base.
Aspect 64 generally concerns the system of any previous aspect in which the base is configured to receive the cable.
Aspect 65 generally concerns the system of any previous aspect including a base including spacers.
Aspect 66 generally concerns the system of any previous aspect in which the spacers define one or more wire grooves.
Aspect 67 generally concerns the system of any previous aspect including spacers configured to align each wire in a separate wire groove.
Aspect 68 generally concerns the system of any previous aspect in which the spacers include tips.
Aspect 69 generally concerns the system of any previous aspect in which the tip slopes towards a point on one end of the spacer.
Aspect 70 generally concerns the system of any previous aspect in which the tips guide the wires into the wire grooves as the wire slides along the base.
Aspect 71 generally concerns the system of any previous aspect in which the spacers are configured to align each wire with one contact.
Aspect 72 generally concerns the system of any previous aspect in which the wire groove is aligned with one contact.
Aspect 73 generally concerns the system of any previous aspect in which the base is configured to align each wire with one contact.
Aspect 74 generally concerns the system of any previous aspect in which the base aligns each wire with one contact as the cable is positioned in the plug body.
Aspect 75 generally concerns the system of any previous aspect in which the base is configured to couple to the cover via a snap-fit connection.
Aspect 76 generally concerns the system of any previous aspect in which the cover includes cover walls.
Aspect 77 generally concerns the system of any previous aspect in which the cover walls define tab openings.
Aspect 78 generally concerns the system of any previous aspect in which the base includes base walls.
Aspect 79 generally concerns the system of any previous aspect in which the base walls nest between the cover walls when the connector closes.
Aspect 80 generally concerns the system of any previous aspect in which the base wall includes a hump.
Aspect 81 generally concerns the system of any previous aspect in which the cover defines a recess.
Aspect 82 generally concerns the system of any previous aspect in which the hump extends into the recess when the connector is in the closed position.
Aspect 83 generally concerns the system of any previous aspect in which the base includes one or more tabs.
Aspect 84 generally concerns the system of any previous aspect in which the cover defines one or more tab openings.
Aspect 85 generally concerns the system of any previous aspect in which the tab openings retain the tabs when the modular connector plug is closed.
Aspect 86 generally concerns the system of any previous aspect in which the tabs secure the base against the cover.
Aspect 87 generally concerns the system of any previous aspect in which the base includes a leaf.
Aspect 88 generally concerns the system of any previous aspect in which the cover includes a pivot pin.
Aspect 89 generally concerns the system of any previous aspect in which the leaf defines a pin opening.
Aspect 90 generally concerns the system of any previous aspect in which the pivot pin is positioned in the pin opening.
Aspect 91 generally concerns the system of any previous aspect in which the pivot pin is free to rotate within the pin opening.
Aspect 92 generally concerns the system of any previous aspect in which the pivot pin and the pin opening support the cover to rotate relative to the base.
Aspect 93 generally concerns the system of any previous aspect in which the pivot pin define a chamfered surface.
Aspect 94 generally concerns the system of any previous aspect in which the chamfered surface facilitates sliding the cover between the leaves on the base.
Aspect 95 generally concerns the system of any previous aspect in which the base defines a cam surface.
Aspect 96 generally concerns the system of any previous aspect in which the cover contacts the cam surface during rotation.
Aspect 97 generally concerns the system of any previous aspect in which the cam surface is rounded.
Aspect 98 generally concerns the system of any previous aspect in which the base includes a ledge.
Aspect 99 generally concerns the system of any previous aspect in which the cover defines a notch.
Aspect 100 generally concerns the system of any previous aspect in which the notch and the ledge align the cover and the base during rotation.
Aspect 101 generally concerns the system of any previous aspect in which the notch receives the ledge as the modular connector plug closes.
Aspect 102 generally concerns the system of any previous aspect in which the cover and the base include ridges.
Aspect 103 generally concerns the system of any previous aspect in which the ridges

extend into the cavity.
Aspect 104 generally concerns the system of any previous aspect in which the ridges are configured to compress the cable within the plug body.
Aspect 105 generally concerns the system of any previous aspect in which the ridges bite onto the cable when the modular connector plug attaches to the cable.
Aspect 106 generally concerns the system of any previous aspect in which the cable includes a sheath that surrounds the wires.
Aspect 107 generally concerns the system of any previous aspect in which the ridges provide strain relief for the wires.
Aspect 108 generally concerns the system of any previous aspect in which the plug body is movable between an open position and a closed position.
Aspect 109 generally concerns the system of any previous aspect in which the plug body is configured to receive the cable in the open position.
Aspect 110 generally concerns the system of any previous aspect in which the plug body is configured to clamp to the cable in the closed position.
Aspect 111 generally concerns the system of any previous aspect in which the cover is fixed to the base in the closed position.
Aspect 112 generally concerns the system of any previous aspect including a modular connector plug including a plug body.
Aspect 113 generally concerns the system of any previous aspect including a plug body made of an insulative material.
Aspect 114 generally concerns the system of any previous aspect including one or more contacts fixed to the plug body.
Aspect 115 generally concerns the system of any previous aspect in which the contacts are made of an electrically conductive material.
Aspect 116 generally concerns the system of any previous aspect in which the plug body defines slots.
Aspect 117 generally concerns the system of any previous aspect in which the contacts are positioned in the slots.
Aspect 118 generally concerns the system of any previous aspect in which the plug body does not permanently deform when attaching to the cable.
Aspect 119 generally concerns the system of any previous aspect in which the contacts are fixed to the plug body.
Aspect 120 generally concerns the system of any previous aspect in which closing the plug body electrically connects the contacts to the wires.
Aspect 121 generally concerns the system of any previous aspect in which the plug body is box-shaped.
Aspect 122 generally concerns the system of any previous aspect in which the contacts are positioned side-by-side in a row.
Aspect 123 generally concerns the system of any previous aspect in which the modular connector plug supports multiple arrangements of wires within the plug body.
Aspect 124 generally concerns the system of any previous aspect in which closing the plug body forces the contacts into the wires.
Aspect 125 generally concerns the system of any previous aspect in which the rotating the base relative to the cover moves the plug body between the open position and the closed position.
Aspect 126 generally concerns the system of any previous aspect in which the contacts are positioned in the cover.
Aspect 127 generally concerns the system of any previous aspect in which the base and the cover are fixed together in the closed position.
Aspect 128 generally concerns the system of any previous aspect in which the base is coupled to the cover on one end.
Aspect 129 generally concerns the system of any previous aspect in which the modular connector plug is in the form of a standardized plug shape.
Aspect 130 generally concerns the system of any previous aspect in which the plug body includes a snap-fit connection.
Aspect 131 generally concerns the system of any previous aspect in which the snap-fit connection fixes the cover to the base in the closed position.
Aspect 132 generally concerns the system of any previous aspect including a modular connector plug including a plug body and contacts held by the plug body.
Aspect 133 generally concerns the system of any previous aspect in which the plug body is configured to crimp wires with the contacts in a toolless manner.
Aspect 134 generally concerns the system of any previous aspect in which the plug body is configured to crimp wires with the contacts to establish an electrical connection between the wires and the contacts in a toolless manner.
Aspect 135 generally concerns the system of any previous aspect in which the plug body has a base and a cover coupled to the base in a pivotal manner.
Aspect 136 generally concerns the system of any previous aspect in which the contacts are secured to the cover.
Aspect 137 generally concerns the system of any previous aspect in which the plug body has one or more pivot pins that secure the cover to the base in the pivotal manner.
Aspect 138 generally concerns the system of any previous aspect in which the contacts are positioned along the cover to form a class 2 lever.
Aspect 139 generally concerns the system of any previous aspect in which the contacts are positioned proximal to the pivot pins to form a class 2 lever that promotes crimping between the wires and the contacts.
Aspect 140 generally concerns the system of any previous aspect in which the modular connector plug is plugged into a modular socket.
Aspect 141 generally concerns the system of any previous aspect in which the modular connector plug and the modular socket form a modular connector.
Aspect 142 generally concerns the system of any previous aspect in which the modular connector plug has a rectangular cross-sectional shape.
Aspect 143 generally concerns the system of any previous aspect in which the modular socket defines a socket cavity with a rectangular cross-sectional shape.
Aspect 144 generally concerns the system of any previous aspect in which the modular connector plug has an 8-position 8-contact (8P8C) arrangement.
Aspect 145 generally concerns the system of any previous aspect in which the modular connector plug has a 6-position 6-contact (6P6C) arrangement.
Aspect 146 generally concerns the system of any previous aspect in which the modular connector plug has a 4-position 4-contact (4P4C) arrangement.
Aspect 147 generally concerns the system of any previous aspect including an insert configured to align the wires in the modular connector plug.
Aspect 148 generally concerns the system of any previous aspect in which the insert defines one or more wire holes configured to receive the wires.
Aspect 149 generally concerns the system of any previous aspect in which the insert defines one or more slots configured to receive the wires.
Aspect 150 generally concerns the system of any previous aspect in which the insert is separate part from the modular connector plug.
Aspect 151 generally concerns the system of any previous aspect in which the insert is integrated into the modular connector plug.
Aspect 152 generally concerns the system of any previous aspect in which the insert is clipped inside the modular connector plug.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a perspective view of a system.

FIG. 2 is a front perspective view of a modular connector plug from the FIG. 1 system.

FIG. 3 is a rear perspective view of the FIG. 2 modular connector plug.

FIG. 4 is a perspective view of a base and a restraint from the FIG. 2 modular connector plug.

FIG. 5 is a cross-sectional perspective view of the FIG. 4 base and restraint as taken along line 5-5 in FIG. 4.

FIG. 6 is a perspective view of the FIG. 4 base.

FIG. 7 is a perspective view of the FIG. 4 restraint.

FIG. 8 is a perspective view of the FIG. 4 restraint rotated outward from the base.

FIG. 9 is a perspective view of the FIG. 2 modular connector plug in an open position and a cable.

FIG. 10 is a perspective view of a cover from the FIG. 2 modular connector plug.

FIG. 11 is a perspective view of a contact from the FIG. 10 cover.

FIG. 12 is a top view of the FIG. 11 contact.

FIG. 13 is a side view of the FIG. 2 modular connector plug.

FIG. 14 is a cross-sectional view of the FIG. 2 modular connector plug as taken along line 14-14 in FIG. 13.

FIG. 15 is a top view of the FIG. 9 modular connector plug coupled to the cable.

FIG. 16 is a cross-sectional view of the FIG. 15 modular connector plug and cable as taken along line 16-16 in FIG. 15.

FIG. 17 is a top view of the FIG. 9 modular connector plug and multiple wires from the FIG. 9 cable arranged in a first conductor arrangement.

FIG. 18 is a top view of the FIG. 17 modular connector plug and wires arranged in a second conductor arrangement.

FIG. 19 is a perspective view of an insert used with the modular connector plug.

FIG. 20 is a perspective view of the FIG. 19 insert coupled to the FIG. 4 base.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

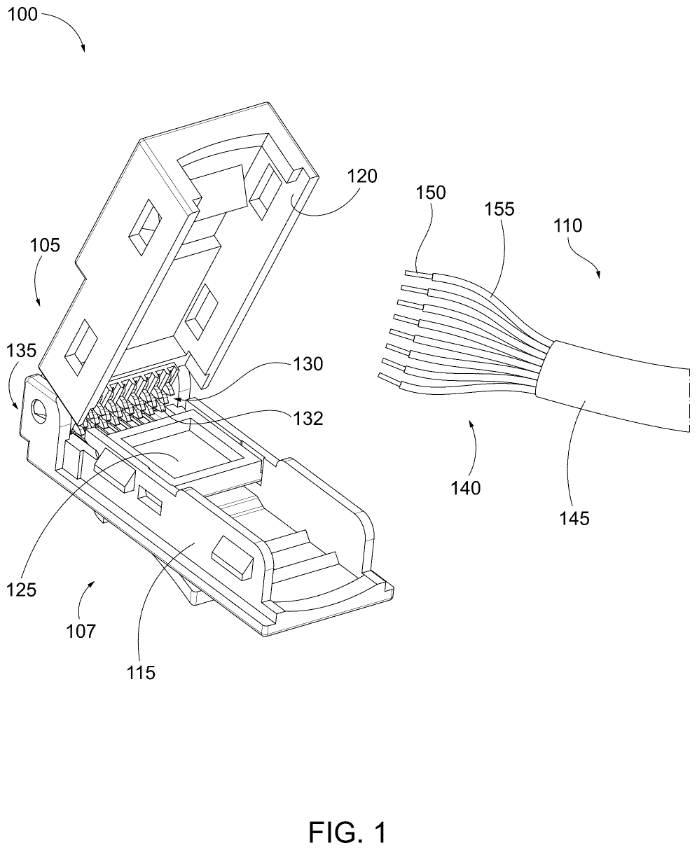

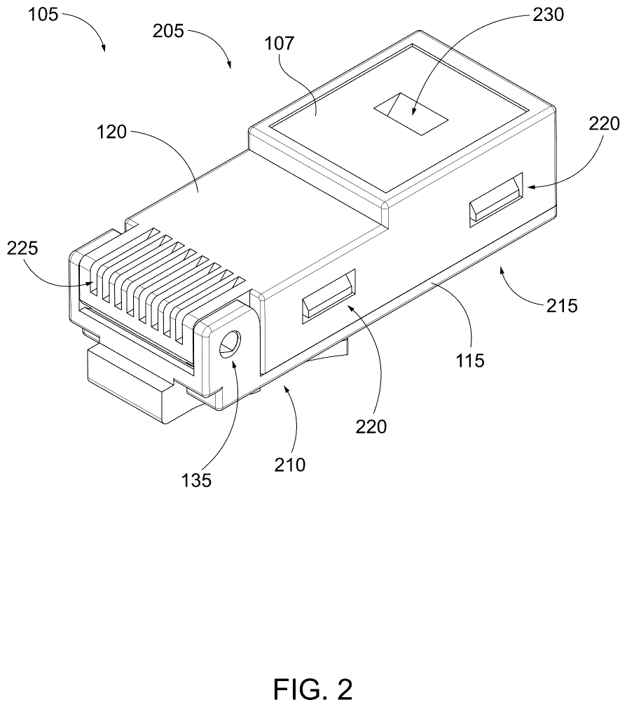

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

FIG. 1 depicts a pluggable modular connector system 100. The system 100 is generally configured to electrically connect multiple wires to pins in a port, socket, outlet, and/or another type of terminal. Typically, the system 100 allows a user to toollessly connect the wires to the terminal. For example, a user does not need a crimping tool, wire stripper, and/or other tools. The system 100 generally allows a user to customize the arrangement of the wires so as to connect the wires to the pins according to a variety of pinouts. Particularly, the system 100 supports a user to customize the arrangement of wires while still connecting to a socket with a standard shape and/or size. The system 100 generally includes a modular connector plug 105 and a cable 110. The modular connector plug 105 is configured to attach to the cable 110. The modular connector plug 105 generally uses a standard shape, such as a plug shape that mirrors the shape of standard sockets and/or jacks. The modular connector plug 105 supports a variety of conductor arrangements so as to connect conductors to the socket according to a variety of pinouts. In one example, the modular connector plug 105 is a Registered Jack (RJ) 45 connector or another type of 8-position 8-conductor (8P8C) connector. In another example, the modular connector plug 105 is a different type of modular connector. The modular connector plug 105 is generally pluggable into an outlet, port, jack, and/or other terminal. For example, the modular connector plug 105 is pluggable into an Ethernet port, such as on a router, modem, computer, network switch, and/or another device. In one example, the cable 110 is a Category 6 cable, such as an Ethernet cable. The modular connector plug 105 generally makes an electrical and a mechanical connection between the cable 110 and a socket. The modular connector plug 105 is generally configured to clamp onto the cable 110 and secure the cable 110 within the modular connector plug 105. The modular connector plug 105 is configured to electrically connect multiple conductors in the cable 110 to separate conductors in the modular connector plug 105. The modular connector plug 105 allows a user to connect multiple conductors in the cable 110 to multiple pins and/or contact points in a port. For example, the modular connector plug 105 allows a user to make such electrical connections along multiple separate conduction paths. Further, the modular connector plug 105 enables a user to attach the modular connector plug 105 to the cable 110 without having to unscrew and/or disassemble part of the modular connector plug 105. The modular connector plug 105 allows the user to secure the cable 110 in the modular connector plug 105 through a single motion. The modular connector plug 105 is configured to automatically and reliably attach to every wire and/or conductor in the cable 110.

As illustrated, the modular connector plug 105 typically includes a plug body 107 and one or more contacts 130. The plug body 107 generally forms the structure of the modular connector plug 105 and is made of a rigid material. In the FIG. 1 illustration, the plug body 107 is open so as to receive the cable 110. After receiving the cable 110, a user can close the plug body 107 to couple the modular connector plug 105 to the cable 110. Generally, the modular connector plug 105 opens and closes by opening and closing the plug body 107. The contacts 130 are made of a conductive material, such as copper and/or aluminum. The plug body 107 is typically made of an insulative material, such as plastic. Constructing the plug body 107 using an insulative material mitigates or fully prevents shorts between the contacts 130 and/or with external conductors. Further, by insulating and separating the contacts 130 from each other, the plug body 107 enables conductors in the cable 110 to electrically connect to the contacts 130 in a desired arrangement. For example, the plug body 107 ensures that each conductor connects only to the appropriate contact 130 based on the way a user arranges conductors in the plug body 107.

The plug body 107 generally includes a base 115, a cover 120, and a restraint 125. The base 115 and the cover 120 are generally configured to enclose the cable 110 when the modular connector plug 105 couples to the cable 110. The base 115 and the cover 120 together form the structure of the plug body 107. The base 115, the cover 120, and the restraint 125 are made of a rigid material, such as plastic. In one example, the base 115, the cover 120, and the restraint 125 are formed as separate pieces, such as through injection molding and/or another technique. The base 115 and the cover 120 are configured to mechanically couple together. In one example, the base 115 is configured to receive the cable 110. The restraint 125 is configured to compress the cable 110 against the base 115. By compressing the cable 110 against the base 115, the restraint 125 is configured to help maintain the position of the cable 110 within the base 115. In one example, the base 115 and restraint 125 allow a user to slide the cable 110 between the base 115 and restraint 125. For instance, the restraint 125 is fixed in position relative to the base 115 before a user inserts the cable 110. In an alternate example, the modular connector plug 105 allows a user to position the cable 110 within the base 115 and then to attach the restraint 125 to compress the cable 110 against the base 115. In another alternate example, the modular connector plug 105 does not include the restraint 125. In yet another example, the restraint 125 is varied in one or more ways from the FIG. 1 example.

The modular connector plug 105 is configured to electrically connect to a socket and/or jack using the contacts 130. For example, the contacts 130 are configured to contact pins and/or pads in a socket. In the illustrated example, the contacts 130 are in the form of plates 132. Alternatively, in other examples, the contacts 130 include pads, sockets, tabs, pins, and/or another type of electrical contact. The cover 120 is configured to separate the contacts 130 so as to electrically isolate the contacts 130 from one another. In one example, the contacts 130 are gold-plated and/or platinum-plated. In the FIG. 1 example, the modular connector plug 105 includes eight contacts 130 and supports connecting up to eight wires 140. In an alternate example, the modular connector plug 105 includes a different number of contacts 130, such as four, six, ten, or another amount.

The base 115 and the cover 120 are rotatably coupled through a hinge 135. The hinge 135 allows the plug body 107 to open and close. The hinge 135 is generally formed by interlocking portions of the base 115 and the cover 120. In an alternate example, the hinge 135 includes one or more separate pieces from the base 115 and the cover 120. After a user positions the cable 110 in the base 115, the hinge 135 allows the user to rotate the cover 120 to couple the base 115 and the cover 120. The modular connector plug 105 is configured to attach to the cable 110 when the base 115 couples to the cover 120. The plug body 107 generally aligns the base 115 and the cover 120 during rotation about the hinge 135, such as through one or more guides and/or interlocking parts. As should be appreciated, in other versions, the plug body 107 opens and closes in a different way, such as through another type of rotational and/or sliding joint. In yet another version, the base 115 and the cover 120 are able to fully detach from one another.

As illustrated, the cable 110 includes multiple wires 140 and a sheath 145. The wires 140 support distinct conduction paths through the cable 110. The sheath 145 is configured to enclose the multiple wires 140. By enclosing the wires 140, the sheath 145 is configured to physically protect the wires 140 and to organize the wires 140 in a consistent shape. In one example, the wires 140 are twisted together within the sheath 145, and the sheath 145 maintains the twisted orientation of the wires 140. Each wire 140 includes a conductor 150 and an insulator 155. The conductor 150 is made of conductive material, such as copper and/or aluminum. In one example, the conductor 150 is a solid piece of conductive material. In another example, the conductor 150 includes multiple separate and insulated strands of conductive material. The insulators 155 electrically isolate the conductors 150 from one another. By separating the conductors 150, the insulators 155 support each wire 140 to support a distinct conduction path. Further, supporting multiple distinct conduction paths allows a user to utilize various pinouts by adjusting the arrangement of the wires 140 within the modular connector plug 105.

The modular connector plug 105 is configured to electrically connect the conductor 150 of each wire 140 to one contact 130 when the plug body 107 couples to the cable 110. The contacts 130 are configured to contact, pierce, and/or compress the wires 140 in place within the modular connector plug 105. In this way the contacts 130 are configured to mechanically couple to the wires 140. Generally, the modular connector plug 105 terminates the wires 140 when the modular connector plug 105 attaches to the cable 110. In other words, the termination of the wires 140 occurs when the modular connector plug 105 clamps onto the wires 140. For instance, a user does not have to cut, strip, and/or modify the wires 140 in another way before connecting the contacts 130 to the wires 140. In one example, the contacts 130 automatically cut through the insulators 155 on the wires 140 to contact the conductors 150. In this way, the modular connector plug 105 does not require a user to strip the insulators 155 from each wire 140 before coupling the modular connector plug 105 to the cable 110. In an alternate example, the contacts 130 are configured to couple to the conductors 150 after the wires 140 are stripped. The modular connector plug 105 generally completes termination of the wires 140 once the plug body 107 is closed. By contacting conductors 150 and mechanically securing the wires 140, the contacts 130 are configured to reliably electrically connect to the wires 140. In the illustrated example, each contact 130 is configured to connect to only one wire 140. The plug body 107 is configured to insulate the contacts 130 from one another and to separate the wires 140. In an alternate example, the modular connector plug 105 is configured to support a different number of electrical conduction paths and/or connect the contacts 130 and the wires 140 in a different way.

Referring to FIG. 2, the modular connector plug 105 is configured to be in a closed position 205. In the closed position 205, the base 115 and the cover 120 are fixed together. The base 115 and the cover 120 are rotated toward one another about the hinge 135 to arrange the modular connector plug 105 in the closed position 205. The shape of the plug body 107 in the closed position 205 is generally rectangular and/or box-shaped. Using the box shape allows the contacts 130 to be arranged in a uniform way across a side of the plug body 107. Using a generally rectangular and/or box shape facilitates manufacturing the plug body 107 by allowing the contacts 130 to be positioned in a uniform and even way. Further, the box-shape generally requires less complicated manufacturing processes than other types of connectors. The plug body 107 typically is shaped to plug into a socket. In one example, the plug body 107 is in the shape of a traditional RJ45 connector in the closed position 205. In another example, the plug body 107 is in the shape of another standard modular connector shape with a different number of conductor positions (P) or conductors (C), such as a 4P4C, 6P2C, 6P4C, 6P6C, 10P10C, and/or another type of connector. Following the standard shape for the plug body 107 allows the modular connector plug 105 to be used in many different applications. Additionally, the size of the plug body 107 is on a similar magnitude as the size of the cable 110. The size of the plug body 107 supports a compact form for the modular connector plug 105. The compact shape of the modular connector plug 105 further facilitates using the modular connector plug 105 in many different settings. For example, the compact shape allows the modular connector plug 105 to plug into sockets situated in tight spaces. Additionally, the compact shape of the modular connector plug 105 reinforces the stability of the coupling between the modular connector plug 105 and the cable 110. For example, sizing the plug body 107 closely to the size of the cable 110 supports the modular connector plug 105 to stay attached to the cable 110 and the socket when the cable 110 is jostled, yanked, pulled, and/or agitated in another way.

In one example, the plug body 107 is shaped such that the modular connector plug 105 can only be plugged into a socket in one orientation. For example, the plug body 107 is keyed so as to match the shape of a socket. Keying the plug body 107 in this way ensures that the modular connector plug 105 connects the wires 140 to the appropriate pins and/or pads in the socket. As illustrated, the plug body 107 includes a head 210 and a receptacle 215. The head 210 is configured to insert into a jack and/or socket, such as an Ethernet port. The receptacle 215 is configured to retain the cable 110. In one example, the receptacle 215 is larger in width and/or thickness than the head 210. The larger size of the receptacle 215 provides more space to contain the sheath 145 of the cable 110. Further, the larger size of the receptacle 215 generally facilitates a user to grab the modular connector plug 105 when attaching or detaching the modular connector plug 105 from a socket and/or jack.

The base 115 and the cover 120 are configured to couple using one or more types of joints and/or fasteners. In the illustrated example, the modular connector plug 105 includes a snap-fit connection 220 that is configured to couple the base 115 and the cover 120. In one example, the plug body 107 includes multiple snap-fit connections 220 that are evenly positioned on opposite sides of the plug body 107. In an alternate example, the snap-fit connections 220 are positioned and/or arranged in another way. Although the plug body 107 is made of rigid material, the base 115 and the cover 120 are configured to flex to a limited extent. For example, the base 115 and/or the cover 120 are configured to flex just enough to allow the snap-fit connection 220 to function. The base 115 and the cover 120 are rigid enough to maintain a consistent shape around the snap-fit connections 220 when the base 115 and the cover 120 are coupled. The snap-fit connection 220 facilitates closing the modular connector plug 105 and securing the cable 110 because the snap-fit connection 220 enables the base 115 and the cover 120 to couple using a single motion. The base 115 and the cover 120 only need to be pressed together and/or rotated toward one another about the hinge 135. In one example, the snap-fit connection 220 is configured to prevent or inhibit detachment of the base 115 and the cover 120. In an alternate embodiment, the base 115 and the cover 120 are configured to detach from one another. For instance, the modular connector plug 105 includes a release latch and/or other mechanism to release the snap-fit connection 220 and allow the base 115 and the cover 120 to detach. In such an example, the modular connector plug 105 allows a user to reuse the modular connector plug 105 to attach to a different cable 110.

The plug body 107 defines one or more slots 225. The slots 225 provide space for the contacts 130. In the illustrated example, the cover 120 defines the slots 225 and encloses the contacts 130. In one example, the slots 225 extend fully through the cover 120. The contacts 130 are typically positioned further back in the slots 225 to prevent accidental contact between the contacts 130 and an external conductor. The slots 225 provide a space for pins within a socket and/or jack to extend into the plug body 107 and contact the contacts 130.

In the illustrated example, the plug body 107 defines a divot 230. The divot 230 is positioned at the receptacle 215. The divot 230 facilitates a user grabbing and/or pulling the modular connector plug 105. For example, the divot 230 allows a user to better grip the modular connector plug 105 when plugging or unplugging the modular connector plug 105. In one example, the divot 230 is shaped to accommodate a tool to pull the modular connector plug 105. In another example, the modular connector plug 105 includes a grip and/or is shaped to contour to fingers of a user.

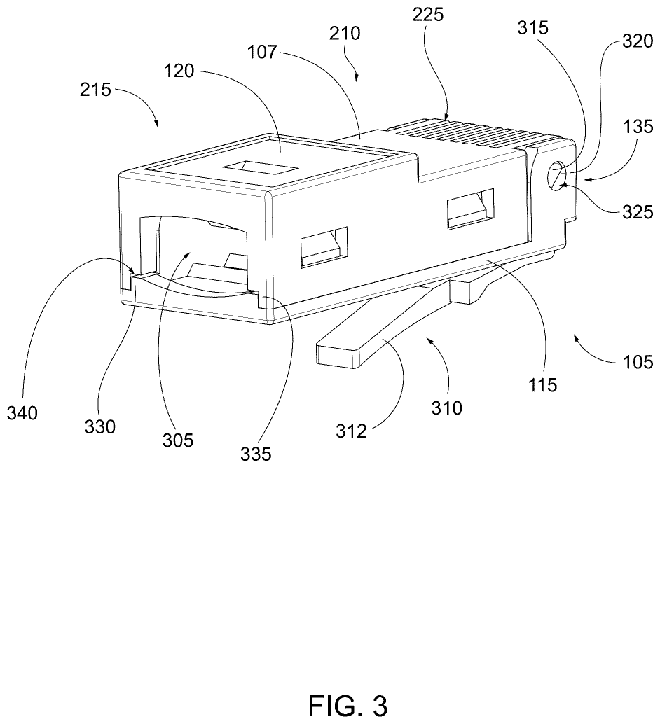

Referring to FIG. 3, the plug body 107 defines a cable opening 305. The cable opening 305 provides a space for the cable 110 when the modular connector plug 105 couples to the cable 110. The base 115 and the cover 120 together define the cable opening 305 in the closed position 205. In one example, the cable opening 305 is shaped to slightly compress the cable 110. By compressing the cable 110, the base 115 and the cover 120 are configured to secure the cable 110 within the modular connector plug 105.

The plug body 107 further includes a latching mechanism 310. The latching mechanism 310 is configured to help secure the head 210 within a socket and/or jack. In the illustrated example, the latching mechanism 310 is in the form of a latch tab 312. The latch tab 312 is configured to flex between multiple positions. In one position, the latch tab 312 is configured to push into a side of a socket to hold the head 210 in the socket. In another position, the latch tab 312 is configured to release from the socket. In an alternate example, the latching mechanism 310 is in another form, such as a lock, hook, and/or clamp as examples. In the illustrated example, the latching mechanism 310 is part of the base 115. For example, the latching mechanism 310 is integrally formed from the same material as the base 115. In an alternate example, the latching mechanism 310 is formed from a different material than the rest of the base 115, such as rubber and/or another flexible material. Further, the latching mechanism 310 functions as keying to ensure that the modular connector plug 105 plugs into a socket in the appropriate orientation. For instance, the latching mechanism 310 makes the shape of the plug body 107 asymmetric across a central line. The asymmetric shape of the plug body 107 ensures that the modular connector plug 105 can be inserted into the socket only in one orientation.

The cover 120 includes one or more pivot pins 315. The pivot pins 315 extend laterally outward from the cover 120 at the head 210. The base 115 includes one or more leaves 320. The leaves 320 are positioned laterally outward from the cover 120 at the head 210. The leaves 320 each define a pin opening 325 configured to receive the pivot pin 315. As illustrated, the pivot pin 315, the leaf 320, and the pin opening 325 form the hinge 135. The cover 120 is configured to rotate relative to the base 115 using the pivot pins 315. The pivot pins 315 and pin openings 325 define the axis of rotation between the base 115 and the cover 120. For example, the pivot pin 315 is generally round and the pin opening 325 forms a round space that approximates the round shape of the pivot pin 315. In this way, the pivot pins 315 are configured to rotate consistently within the pin openings 325. The leaves 320 structurally support the base 115 to rotatably couple to the cover 120 at the hinge 135. In addition to allowing the base 115 and the cover 120 to rotate, the pivot pins 315 and the pin openings 325 are configured to align the base 115 and the cover 120. The pivot pins 315 and the pin openings 325 are arranged so as to align the snap-fit connection 220 and/or other joints between the base 115 and the cover 120. In one example, the pivot pins 315 are integrally formed with the cover 120, and the leaves 320 are integrally formed with the base 115. In an alternate example, the pivot pins 315 and/or the leaves 320 include one or more separate parts from the base 115 and the cover 120.

The base 115 further includes a ledge 330. The ledge 330 extends away from the base 115 on the receptacle 215. The cover 120 includes a rim 335. The rim 335 extends around the cable opening 305 on the cover 120. The ledge 330 and the rim 335 form the boundary of the cable opening 305. The rim 335 defines one or more notches 340 that are configured to receive the ledge 330. In the closed position 205, the ledge 330 is positioned within the notches 340 and the rim 335 is positioned around the ledge 330. The ledge 330, the rim 335, and the notches 340 form a tongue and groove joint between the base 115 and the cover 120. In this way, the ledge 330, the rim 335, and the notches 340 are configured to align the base 115 and the cover 120. Specifically, the ledge 330, the rim 335, and the notches 340 align the base 115 and the cover 120 at the receptacle 215 and around the cable opening 305. In this way, the base 115 and the cover 120 are configured to align consistently across the whole plug body 107, especially in combination with the hinge 135 and the snap-fit connection 220. In the illustrated example, the notches 340 provide a larger space than needed for the ledge 330. The larger space allows the ledge 330 and/or the rim 335 to be manufactured with a large tolerance around the notches 340.

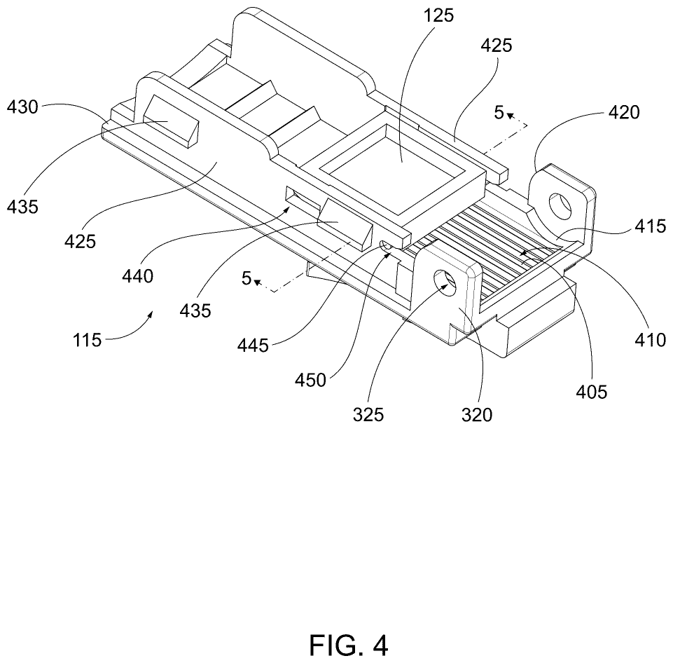

FIG. 4 illustrates the base 115 and the restraint 125. As illustrated, the base 115 includes one or more spacers 405. The base 115 defines wire grooves 410 between the spacers 405. The wire grooves 410 provide spaces for the wires 140 when the base 115 receives the cable 110. The spacers 405 separate the wires 140 when the wires 140 are positioned in the wire grooves 410. Further, the spacers 405 and wire grooves 410 are configured to align the wires 140 within the base 115. By aligning the wires 140, the base 115 ensures that each contact 130 contacts one wire 140 when closing the plug body 107.

The base 115 defines a cam surface 415 and a chamfered edge 420. The cam surface 415 and the chamfered edge 420 are configured to facilitate rotation of the cover 120 relative to the base 115. The base 115 defines the cam surface 415 near the leaves 320. The cam surface 415 is round and generally mirrors a surface on the cover 120. The cam surface 415 provides a smooth surface for the cover 120 to contact as the cover 120 rotates about the hinge 135 relative to the base 115. In this way, the cam surface 415 stabilizes the hinge 135 and facilitates rotation of the cover 120 about the hinge 135. In one example, the cam surface 415 includes multiple surfaces and/or sections. The base 115 defines one chamfered edge 420 on each leaf 320. The chamfered edge 420 is shaped as a curved and/or straight surface that cuts across a corner of the leaf 320. The chamfered edge 420 provides clearance between the base 115 and the cover 120 near the hinge 135. By providing clearance, the chamfered edge 420 allows the modular connector plug 105 to open to a wide angle to facilitate a user inserting the cable 110. In one example, the plug body 107 is configured to open to an angle greater than 60 degrees, greater than 75 degrees, greater than 90 degrees, and/or another angle between the base 115 and the cover 120. In another example, the chamfered edge 420 is rounded and supports a portion of the cover 120 during rotation. For example, the chamfered edge 420 is configured to function in a similar way as the cam surface 415 to facilitate rotation of the cover 120 relative to the base 115.

The base 115 includes base walls 425, a lip 430, and one or more tabs 435. One base wall 425 is positioned on each lateral side of the base 115. The lip 430 extends outside the base walls 425. In one example, the lip 430 is split into multiple sections. When the modular connector plug 105 is in the closed position 205, the cover 120 is generally positioned around the base walls 425 and against the lip 430. The tabs 435 are positioned on the base walls 425. The tabs 435 are part of the snap-fit connection 220 between the base 115 and the cover 120. In the illustrated example, the tabs 435 are partially sloped. The sloped shape guides the cover 120 around and over the tabs 435 as a user closes the modular connector plug 105. The tabs 435 are configured to hold the cover 120 in place against the base 115 in the closed position 205. In one example, the base 115 secures a portion of the cover 120 between the lip 430 and the tabs 435. In the illustrated example, two tabs 435 are positioned on each base wall 425. The tabs 435 and the base walls 425 on either lateral side are symmetric to one another. The symmetrical arrangement of the tabs 435 and base walls 425 supports the base 115 and the cover 120 to couple evenly across the whole plug body 107. In an alternate example, the number and/or arrangement of the tabs 435 and/or the base walls 425 is different from the FIG. 4 example.

The base 115 is configured to couple to the restraint 125 in a variety of ways. In the illustrated embodiment, the restraint 125 couples to the base 115 using one or more snap-fit connections 440. Further, the restraint 125 is rotatably coupled to the base 115. The restraint 125 includes one or more pegs 445. The pegs 445 extend on the lateral sides of the restraint 125. In one example, the pegs 445 are integrally formed with the restraint 125. The base 115 defines one or more peg slots 450. The peg slots 450 extend through the base walls 425. The peg slots 450 are shaped to receive the pegs 445 of the restraint 125. The peg slots 450 are generally L-shaped. The L-shape allows the pegs 445 to slide into the peg slots 450 from one end of the base walls 425. The peg slots 450 are shaped to retain the pegs 445 after sliding into the peg slots 450. In one example, the pegs 445 are free to rotate within the peg slots 450. In another example, the pegs 445 are configured to rest within the peg slots 450. The snap-fit connections 440 couple the restraint 125 and the base 115 at one end. When the snap-fit connections 440 couple the restraint 125 and the base 115, the peg slots 450 retain the pegs 445 to secure the position of the other end of the restraint 125. In an alternate embodiment, the restraint 125 is part of and integrally formed with the base 115. In another alternate embodiment, the modular connector plug 105 does not include the restraint 125.

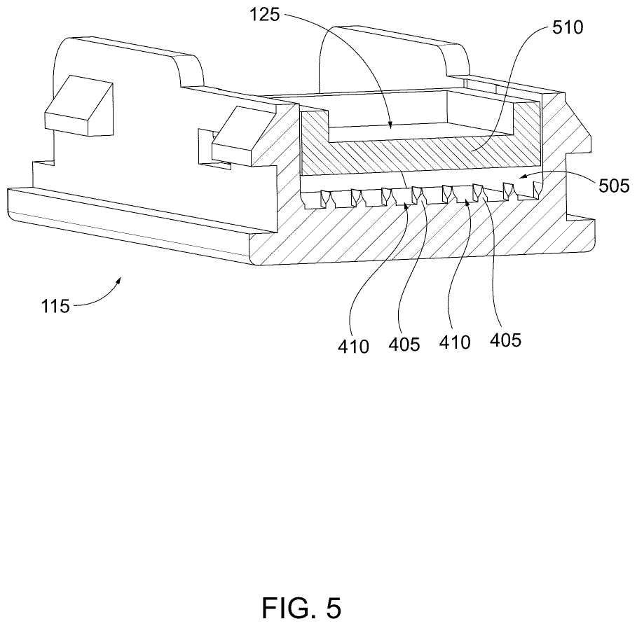

Referring to FIG. 5, the restraint 125 and the base 115 define a gap 505. The gap 505 provides space for the wires 140 between the restraint 125 and the base 115. Further, the restraint 125 includes a panel 510. The panel 510 is a generally flat section of the restraint 125. The panel 510 provides a uniform surface for the restraint 125 to contact the wires 140. In one example, the modular connector plug 105 allows a user to slide the wires 140 into the gap 505 before closing the modular connector plug 105. The gap 505 is generally the same size as a width of the wire 140. For instance, the gap 505 is the same as or slightly smaller than a width of the wire 140 so as to compress the wire 140 between the restraint 125 and the base 115. As illustrated, the spacers 405 overlap at least partially with the restraint 125 along the base 115. By overlapping, the restraint 125 is configured to press the wires 140 against the base 115 within the wire grooves 410 between the spacers 405. Such an arrangement ensures that the wires 140 are held in place and oriented along the wire grooves 410. In another example, the spacers 405 extend at least the whole length of the restraint 125. The uniform surface of the panel 510 supports the restraint 125 to evenly apply force to all the wires 140 positioned in the gap 505. In one example, the spacers 405 define rounded surfaces and come to a point. For instance, the rounded surfaces on the spacers 405 mirror or approximate outer surfaces on the wires 140. The rounded surfaces of the spacers 405 support the base 115 to align and secure the position of the wires 140.

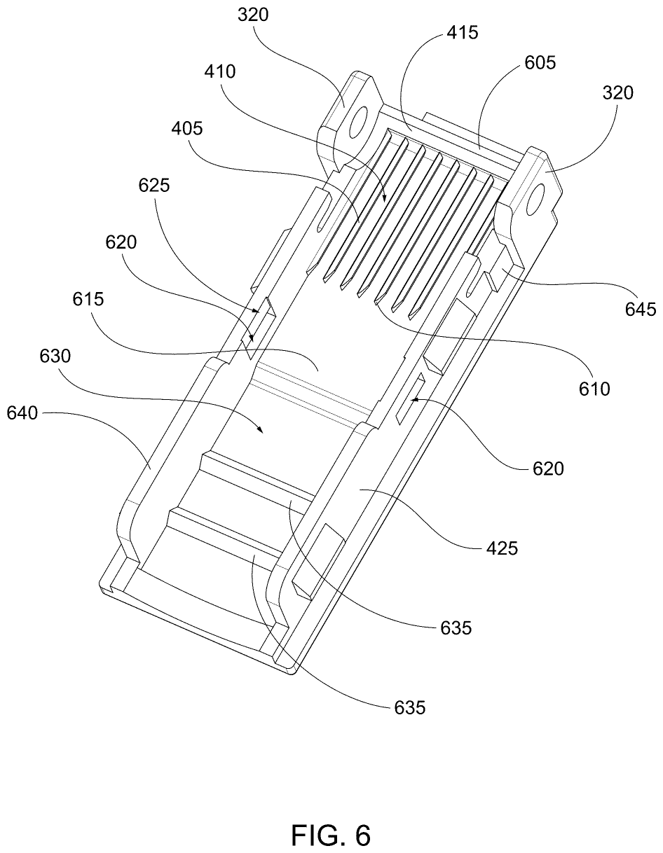

FIG. 6 illustrates the base 115 with the restraint 125 detached. As shown, the base 115 includes a stopper 605. The stopper 605 is positioned on the head 210. The stopper 605 forms a boundary on one end of the wire grooves 410. By forming a boundary, the stopper 605 prevents the wires 140 from sliding past the stopper 605 when a user inserts the cable 110 into the base 115. The stopper 605 allows a user to insert the wires 140 fully into the base 115 until contacting the stopper 605. In one example, the stopper 605 stops the wires 140 so as to prevent the wires 140 from obstructing the hinge 135. In an alternate example, the base 115 does not include the stopper 605. In such an example, the base 115 allows a user to slide the wires 140 past an end of the base 115 and to trim excess length on the wires 140 after coupling the modular connector plug 105 and the cable 110.

The spacers 405 generally include tips 610. One tip 610 is positioned on an end of each spacer 405 opposite the stopper 605. The tip 610 typically slopes into a point from the rest of the spacer 405. The tips 610 are shaped to guide the wires 140 into the wire grooves 410 between the spacers 405. The base 115 includes a platform 615 near the spacers 405. The platform 615 is raised from the rest of the base 115 between the base walls 425. The spacers 405 extend from the platform 615. The platform 615 defines a uniform surface for the wires 140 to slide along and rest against. In combination with the panel 510 on the restraint 125, the platform 615 is configured to apply a uniform force to the wires 140. In this way, the base 115 and the restraint 125 are configured to inhibit or prevent movement of each wire 140 after a user slides the cable 110 along the base 115. In the illustrated example, the platform 615 smoothly transitions into the rest of the base 115 through a curved and/or sloped surface. In another example, the base 115 includes a different structure to support the wires 140. For instance, the base 115 includes one or more bars that span between the base walls 425.

In the illustrated example, each base wall 425 defines a flange opening 620. The flange opening 620 is part of the snap-fit connection 440 between the base 115 and the restraint 125. A portion of the restraint 125 is positioned within the flange opening 620 when the base 115 and the restraint 125 are coupled. In one example, the flange opening 620 extends fully through the base wall 425. Each base wall 425 further defines a track 625. The track 625 provides clearance for the restraint 125 to slide into the flange opening 620 when coupling to the base 115. The track 625 further guides the restraint 125 into the flange opening 620 as restraint 125 slides into the flange opening 620. In one example, the flange opening 620 and/or the track 625 are rectangularly shaped with right angles. In another example, the flange opening 620 and/or the track 625 are sloped, curved, and/or include non-right angles. For instance, the track 625 transitions into the flange opening 620 at a slope to provide greater clearance where the restraint 125 begins to slide into the base 115. As another example, the flange opening 620 is partially sloped to conform to a sloped portion of the base 115. The flange opening 620 and the track 625 support the base 115 and the restraint 125 to couple quickly and reliably.

The base 115 defines a cavity 630 between the base walls 425. The cavity 630 provides space for the cable 110 as a user slides the cable 110 along the base 115. In one example, the cavity 630 receives the sheath 145 of the cable 110 as the user slides the wires 140 between the restraint 125 and the platform 615. The base 115 further includes one or more base ridges 635 positioned in the cavity 630. The base ridges 635 extend into the cavity 630. By extending into the cavity 630, the base ridges 635 are configured to compress the cable 110 against the cover 120 when closing the plug body 107. Typically, the base ridges 635 are positioned to contact and apply force to the sheath 145 of the cable 110. In the illustrated example, the base 115 includes two base ridges 635. In an alternate example, the base 115 includes just one track 625 or greater than two base ridges 635. The base ridges 635 are sharply angled. In one example, the angled shape allows more reliable molding of the base 115. Further, the angled shape allows the base ridges 635 to partially dig into the sheath 145 to secure the position of the cable 110 in the modular connector plug 105. In another example, the base ridges 635 are smooth and/or form a flat surface that contacts the cable 110.

The base walls 425 further include humps 640. Each hump 640 extends distally in the same orientation as the base wall 425. The hump 640 is configured to fit within the cover 120 at the receptacle 215. The hump 640 helps reinforce the alignment and coupling of the base 115 and the cover 120. Further, the hump 640 defines rounded edges around the corner portions. The rounded edges allow the humps 640 to slide into the cover 120 without being obstructed. For instance, the rounded edges provide additional clearance between the hump 640 and the cover 120.

In the illustrated example, the base 115 includes one or more ledges 645. The ledge 645 is shaped to interface with a portion of the cover 120 near the hinge 135. The ledge 645 forms part of a tongue and groove joint between the base 115 and the cover 120. By positioning the ledge 645 near the leaf 320, the ledge 645 helps to align the base 115 and the cover 120 during rotation about the hinge 135. Specifically, the ledge 645 generally aligns the base 115 and the cover 120 as the modular connector plug 105 closes. As illustrated, the base 115 includes one ledge 645 next to each leaf 320. The ledges 645 are generally symmetrical to one another. In another example, the base 115 does not include the ledges 645.

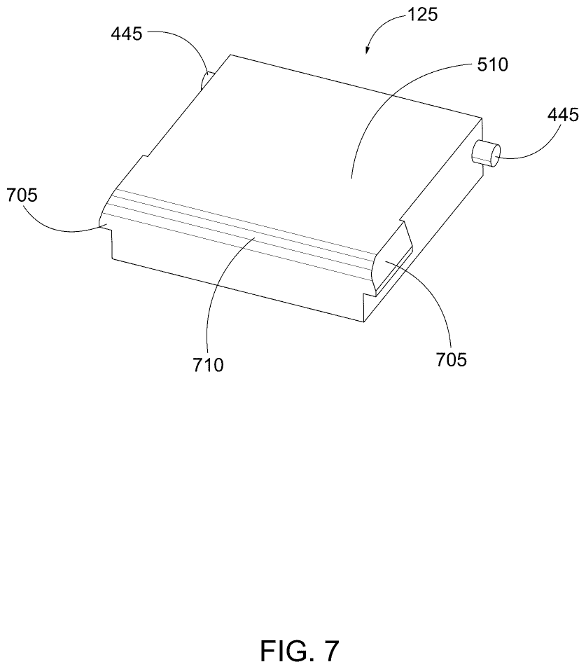

FIG. 7 depicts the restraint 125. The restraint 125 includes one or more flanges 705. The flanges 705 extend outward from the panel 510. The flanges 705 are part of the snap-fit connection 440 between the base 115 and the restraint 125. As the pegs 445 rotate within the peg slots 450, as shown in FIG. 4, the tracks 625 receive the flanges 705 and guide the flanges 705 toward the flange openings 620. In the illustrated example, the flanges 705 are partially sloped. The sloped shape provides greater clearance where the flange 705 begins to slide into the track 625. When the restraint 125 is coupled to the base 115, the flanges 705 extend into the flange openings 620. In one example, the flange 705 has a thickness equal to a thickness of the base wall 425. For instance, the flange 705 sits flush with an outer surface of the base wall 425 when positioned in the flange opening 620.

The restraint 125 defines a guide surface 710. The guide surface 710 is a curved surface that extends across the restraint 125. In one example, the guide surface 710 cuts across a corner of the restraint 125. By cutting into the corner of the restraint 125, the guide surface 710 is configured to guide the wires 140 between the restraint 125 and the base 115 when a user slides the wires 140 along the base 115. For instance, the guide surface 710 provides greater clearance for the wires 140 where the wires 140 begin to slide into the gap 505. As illustrated, the guide surface 710 extends across the flanges 705. In one example, the guide surface 710 allows the restraint 125 to rotate and couple to the base 115 at the snap-fit connection 440 without being obstructed. For instance, the guide surface 710 provides clearance for the flange 705 to rotate into the track 625 and the flange opening 620.

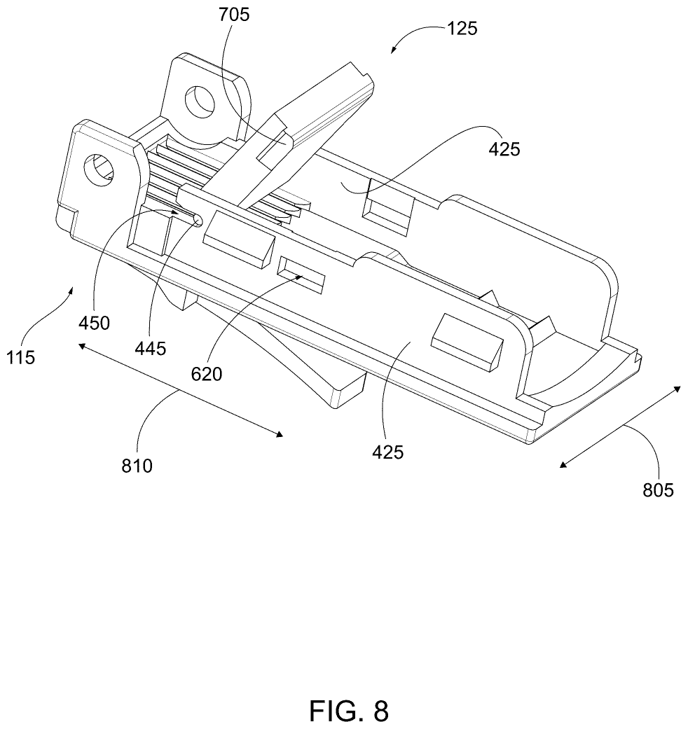

Referring to FIG. 8, the restraint 125 is initially rotated away from the base 115 in one embodiment. As shown, the pegs 445 extend from the restraint 125 along a longitudinal axis 805. The longitudinal axis 805 is oriented in a lateral direction along the base 115. Additionally, a lateral axis 810 extends in a direction transverse to the longitudinal axis 805. The lateral axis 810 is generally oriented along a length of the base 115. The base walls 425 are positioned apart along the longitudinal axis 805. In the illustrated example, an axis of rotation of the restraint 125 is oriented parallel to the longitudinal axis 805. In this orientation, the restraint 125 is initially positioned to span between the base walls 425. The restraint 125 and the base 115 allow a user to slide the wires 140 between the restraint 125 and the base 115 along the lateral axis 810. The user can then rotate the restraint 125 to fix the restraint 125 against the base 115 and compress the wires 140 in place. In one example, the peg slots 450 are shaped to enclose the pegs 445. By enclosing the pegs 445, the restraint 125 is secured to the base 115 at the pegs 445 but is free to rotate about the pegs 445. In such an example, the restraint 125 and the base 115 remain assembled together. For instance, the plug body 107 remains assembled and allows a user to rotate the base 115 and the restraint 125 to couple the cable 110 to the modular connector plug 105.

In another embodiment, the restraint 125 is assembled by fixing the restraint 125 to the base 115. For instance, the plug body 107 does not allow a user to rotate the restraint 125 relative to the base 115 when coupling the cable 110 to the modular connector plug 105. Using separate pieces for the restraint 125 and the base 115 facilitates manufacturing. For example, injection molding the base 115 and the restraint 125 is more reliable and consistent when the base 115 and the restraint 125 are separate parts rather than a single piece of material. Forming the gap 505 between the base 115 and restraint 125 may be inconsistent and/or weaken the structure when forming the base 115 and the restraint 125 as a single piece. To assemble the restraint 125 and the base 115, the pegs 445 of the restraint 125 slide into the peg slots 450 of the base 115. The restraint 125 then couples to the base 115 through the snap-fit connection 440. For example, the restraint 125 is pressed into the base 115 to couple the restraint 125 and the base 115 at the snap-fit connection 440. In an alternate example, the restraint 125 does not include the pegs 445. In such an example, the restraint 125 is configured to couple to the base 115 only through the snap-fit connection 440. Using only the snap-fit connection 440 allows the restraint 125 to couple to the base 115 through a single motion. Coupling the restraint 125 and the base 115 through a single motion facilitates quick and reliable assembly of the modular connector plug 105. In yet another example, the base 115 and the restraint 125 couple through one or more different types of joints, such as a friction fit and/or a tongue and groove joint.

In an alternate embodiment, the restraint 125 is oriented along the base 115 in a different way. In one example, the axis of rotation of the restraint 125 is oriented parallel to the lateral axis 810. Orienting the restraint 125 this way allows the restraint 125 to rotate laterally outward and to be positioned outside the base walls 425 along the longitudinal axis 805. Positioning the restraint 125 outside the base wall 425 allows a user to directly place the wires 140 between the base walls 425. For instance, a user can place the cable 110 in the base 115 and arrange the wires 140 in the corresponding wire grooves 410. The user then may rotate the restraint 125 back between the base walls 425 and fix the restraint 125 to the base 115. Such an arrangement allows a user to see the wires 140 and the spacers 405 as the user positions the wires 140. Alternatively, the spacers 405 are configured to automatically guide the wires 140 into the appropriate positions when a user slides the wires 140 between the restraint 125 and the base 115. As should be appreciated, the modular connector plug 105 is able to utilize a variety of types of the restraint 125. In one example, the base 115 and the restraint 125 incorporate a combination of features from one or more variations. In another example, the modular connector plug 105 does not include the restraint 125. For instance, the base 115 includes one or more clips that hold the wires 140 against the base 115.

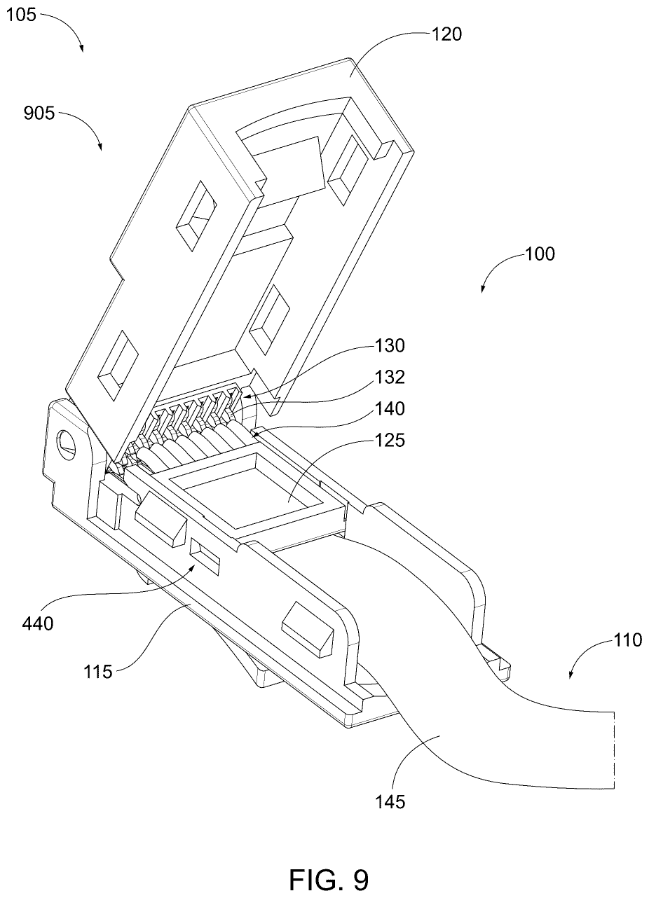

FIG. 9 illustrates the modular connector plug 105 in an open position 905 and with the cable 110 positioned in the base 115. The modular connector plug 105 is generally configured to receive the cable 110 in the open position 905. As illustrated, the plug body 107 is opened to receive the cable 110. The cable 110 is positioned between the restraint 125 and the base 115. In one example, the wires 140 slide into the gap 505 between the restraint 125 and the base 115. The restraint 125 limits movement of the wires 140 and/or compresses the wires 140 against the base 115. In this way, the restraint 125 and the base 115 secure the wires 140 in place after the user positions the wires 140 in the base 115. Further, the sheath 145 is positioned between the base walls 425 in the cavity 630. In one example, the user is able to slide the wires 140 between the restraint 125 and the base 115 until the sheath 145 contacts the restraint 125. Generally, the modular connector plug 105 enables a user to arrange the wires 140 in any way desired. The modular connector plug 105 supports a high degree of customization by allowing a user to arrange the wires 140 according to a variety of pinouts. For example, a user can arrange the wires 140 according to an RJ45 pinout and/or another standard pinout. The side-by-side and uniform arrangement of the contacts 130 facilitates arranging the wires 140 in a desired layout within the modular connector plug 105.

As illustrated, the wires 140 extend past the restraint 125 toward the hinge 135. The spacers 405 align the wires 140 with the contacts 130 on the cover 120. By aligning the wires 140 and the contacts 130, the contacts 130 are configured to electrically connect to the wires 140 when a user closes the modular connector plug 105. For example, the contacts 130 are aligned to puncture the insulation on the wires 140 and contact the conductors in the wires 140. Closing the modular connector plug 105 moves the contacts 130 toward the wires 140 and ensures the contacts 130 contact the wires 140. In the FIG. 9 arrangement, the cover 120 only needs to rotate about the hinge 135 relative to the base 115 to connect the contacts 130 to the wires 140. To complete the coupling of the modular connector plug 105 to the cable 110, a user only needs to rotate the cover 120 such that the modular connector plug 105 moves to the closed position 205.

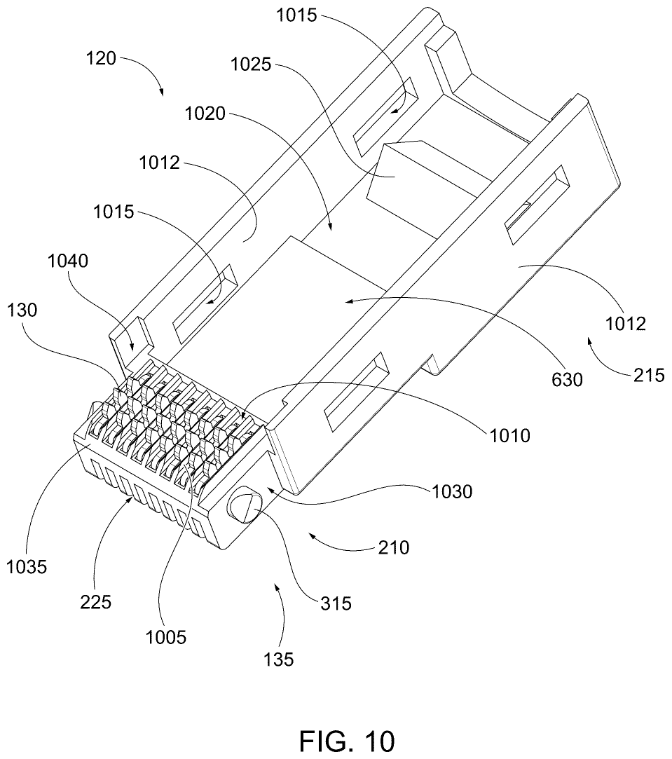

FIG. 10 illustrates the cover 120. As illustrated, the cover 120 includes multiple contacts 130. The contacts 130 are configured to contact pins in a socket and/or jack, such as an Ethernet port. The contacts 130 are configured to contact conductors in the wires 140 so as to support the cable 110 to electrically connect to the socket. The cover 120 further includes one or more dividers 1005. The dividers 1005 separate and electrically isolate the contacts 130 from one another. Further, the dividers 1005 contact the contacts 130 and secure the contacts 130 in the slots 225. Generally, the dividers 1005 extend through the entire head 210 on the cover 120. The dividers 1005 define portions of the slots 225. The dividers 1005 further define multiple contact grooves 1010. The contact grooves 1010 provide a space around each contact 130. The contact grooves 1010 are shaped to receive the wires 140. In one example, the dividers 1005 narrow to a point at one end. By converging to a point, the dividers 1005 are shaped to guide the wires 140 into the contact grooves 1010 when a user closes the modular connector plug 105. In one example, the dividers 1005 are shaped in the same way as the spacers 405 on the base 115. Similarly, in one example, the contact grooves 1010 are shaped in the same way as the wire grooves 410 on the base 115. In another example, the dividers 1005 and the contact grooves 1010 are shaped differently than the spacers 405 and the wire grooves 410. For instance, the dividers 1005 slope to points along straight edges, and the spacers 405 slope to points along curved surfaces. The dividers 1005 and the spacers 405 cooperate to align the wires 140 with the appropriate contacts 130 and to prevent wires 140 from crossing.

The cover 120 includes one or more cover walls 1012. The cover walls 1012 extend along the cover 120. The cover 120 defines the cavity 630 between the cover walls 1012. When the modular connector plug 105 is in the closed position 205, the cover walls 1012 are positioned around the base walls 425 on the base 115. The cover walls 1012 define one or more tab openings 1015. In the illustrated example, each cover wall 1012 defines two tab openings 1015. The tab openings 1015 on each cover wall 1012 are arranged symmetrically to one another. Further, the tab openings 1015 extend fully through the cover walls 1012. The tab opening 1015 is part of the snap-fit connection 220 between the cover 120 and the base 115. The tab openings 1015 are configured to receive the tabs 435 on the base 115. In one example, the tab openings 1015 are rectangularly shaped with right angles. In another example, the tab openings 1015 are sloped, curved, and/or include non-right angles. For instance, the tab opening 1015 is partially sloped to conform to a sloped portion of the tab 435. In an alternate example, the cover walls 1012 further define one or more tracks that guide the tabs 435 on the base 115 into the tab openings 1015. As shown in FIGS. 4 and 5, the tabs 435 are sloped in shape. The sloped shape of the tabs 435 pushes the cover walls 1012 apart slightly as the cover 120 and the base 115 couple. When the cover 120 fully couples to the base 115, the tabs 435 extend into the tab openings 1015 and the cover walls 1012 return to the original positions. The tab openings 1015 support the base 115 and the cover 120 to couple quickly and reliably.

The cover 120 further defines a recess 1020. The recess 1020 extends from the cavity 630. Specifically, the recess 1020 provides space in the receptacle 215 that is additional to the cavity 630. In one example, the recess 1020 provides additional space to receive the sheath 145 of the cable 110. The recess 1020 is further configured to receive the humps 640 of the base 115. When the modular connector plug 105 is in the closed position 205, the base walls 425 on the base 115 are positioned between the cover walls 1012 on the cover 120. The humps 640 extend along the cover walls 1012 within the recess 1020. The interlocking shape of the humps 640 and the recess 1020 help to reinforce coupling between the base 115 and the cover 120.

The cover 120 includes a cover ridge 1025 positioned in the recess 1020. The cover ridge 1025 is configured to compress the cable 110 against the base 115 when the modular connector plug 105 is coupled to the cable 110. Typically, the cover ridge 1025 is configured to push the cable 110 against the base ridges 635 on the base 115. In one example, the cover ridge 1025 is aligned between the two base ridges 635. In this way, the modular connector plug 105 causes the cable 110 to bend and/or wrap around the base ridges 635 and/or cover ridge 1025. By bending and/or compressing the cable 110, the base ridges 635 and cover ridge 1025 facilitate securing the cable 110 within the modular connector plug 105. For instance, the cover ridge 1025 and base ridges 635 provide strain relief for the cable 110 by securing the sheath 145 in the modular connector plug 105. In this way, the cable 110 is secured in the modular connector plug 105 beyond the mechanical coupling between the contacts 130 and wires 140. Further, the cover ridge 1025 is spaced apart from the cover walls 1012 on each side. The base walls 425 slide between the cover ridge 1025 and the cover walls 1012 when the modular connector plug 105 closes. The interlocking between the base walls 425 and the cover ridge 1025 and the cover walls 1012 reinforces the structure of the modular connector plug 105. In an alternate example, the modular connector plug 105 does not include one or both of the base ridge 635 and cover ridge 1025. For instance, the modular connector plug 105 includes a separate mechanism configured to secure the cable 110 within the cavity 630 of the modular connector plug 105. In such an example, the modular connector plug 105 includes a lever that is configured to compress the cable 110 in place within the cavity 630. In one version, the cover 120 includes a lever that compresses the cable 110 against the base 115 when a user rotates the lever. In another version, the base 115 includes a lever that compresses the cable 110 against the cover 120 when a user rotates the lever.

Near the hinge 135, the cover 120 defines a fillet 1035. The fillet 1035 supports the cover 120 to rotate relative to the base 115 about the hinge 135. In one example, the fillet 1035 provides clearance for the cover 120 to rotate about the hinge 135 without being impeded. In another example, the fillet 1035 provides a surface for the base 115 to slide against as the cover 120 rotates relative to the base 115. In the illustrated example, the fillet 1035 extends partially along the dividers 1005. Further, the cover 120 defines leaf slots 1030 that are shaped to receive the leaves 320 on the base 115. The leaf slots 1030 are shaped to accommodate the thickness of the leaves 320 so as to form a consistent shape between the base 115 and the cover 120 when coupling. The pivot pin 315 is positioned within the leaf slot 1030. The pivot pin 315 is chamfered on one portion. The chamfered shape of the pivot pins 315 allows the leaves 320 to slide onto and around the pivot pins 315 when coupling the base 115 and the cover 120 at the hinge 135. For instance, the chamfered shape of the pivot pins 315 guides the leaves 320 around the pivot pins 315 until the pivot pins 315 slide into the pin openings 325 on the leaves 320. The leaves 320 are then able to return to the original positions and to rest in the leaf slot 1030. The pivot pins 315 facilitate quick and reliable assembly of the base 115 and the cover 120 in this way. Further, the pivot pins 315 and leaf slots 1030 support stability between the base 115 and the cover 120 at the hinge 135.

The cover 120 further defines one or more notches 1040. The notches 1040 are shaped to receive the ledges 645 on the base 115. The ledge 645 and the notch 1040 form a tongue and groove joint between the base 115 and the cover 120. By positioning the ledge 645 and the notch 1040 near the hinge 135, the ledge 645 helps to align the base 115 and the cover 120 during rotation. Specifically, the ledge 645 and notch 1040 generally align the base 115 and the cover 120 as the modular connector plug 105 closes. In one example, the notch 1040 exactly mirrors the shape of the ledge 645. In an alternate example, the notch 1040 and/or ledge 645 are shaped differently to provide clearance as the base 115 and the cover 120 rotate. In yet another example, the modular connector plug 105 does not include the ledge 645 and notch 1040.

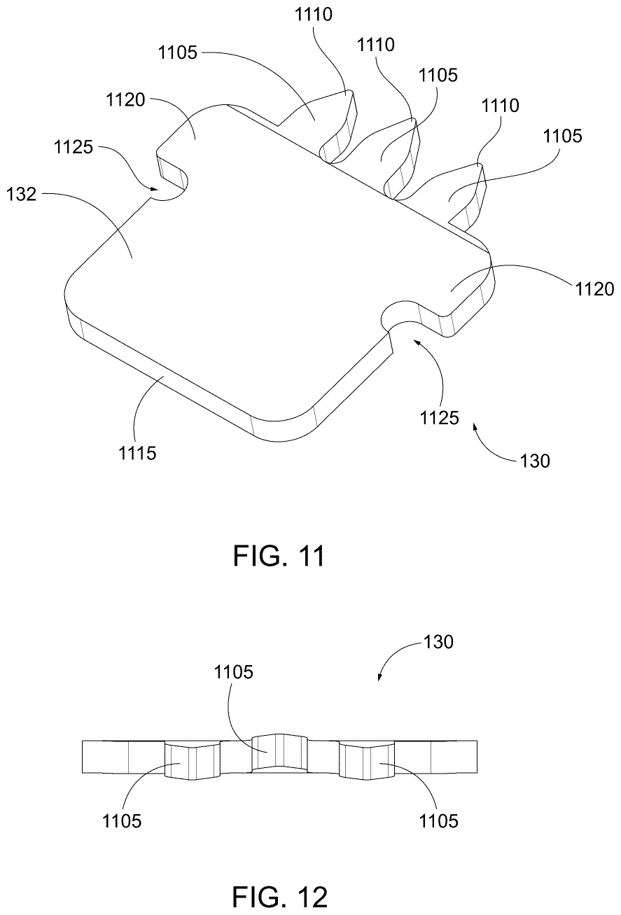

FIGS. 11 and 12 depict the contact 130. In the illustrated example, the contact 130 is in the form of the plate 132. In another example, the contact 130 is in the form of a pad, socket, pin, and/or another type of electrical contact. The contact 130 includes multiple prongs 1105. The prongs 1105 extend outward from the rest of the contact 130. When the modular connector plug 105 couples to the cable 110, the contacts 130 typically contact the wires 140 through the prongs 1105. In one example, the prongs 1105 are configured to pierce through the insulator 155 on the wires 140 to contact the conductor 150 in the wire 140. As illustrated, the prongs 1105 include edges 1110. Each prong 1105 narrows to form one edge 1110. In one example, the edge 1110 forms a sharp enough point to cut through the insulators 155 on the wires 140. In another example, the prongs 1105 are thin and/or flat so as to cut through insulators 155 on the wires 140. In yet another example, the edges 1110 are not configured to cut through the insulator 155. For instance, the prongs 1105 and edges 1110 are shaped to push into the conductor 150 on a stripped wire 140. The shape of the prongs 1105 and edges 1110 allows the contact 130 to contacts the wire 140 at multiple points and/or causes the wire 140 to conform partially to the shape of the contact 130.

As illustrated in FIG. 12, the prongs 1105 are angled at alternating directions along the contact 130. In the illustrated example, two prongs 1105 are angled toward one direction, and one prong 1105 positioned in between is angled toward an opposite direction. The alternating angles of the prongs 1105 facilitate securing the wire 140 against the contact 130. For example, the prongs 1105 apply tension across the wire 140 after contact 130 bites into the wire 140. The tension from the alternating prongs 1105 inhibits the wire 140 from sliding off the prongs 1105 of contact 130. In another example, the alternating angles of the prongs 1105 guide the wire 140 to wrap around and between the prongs 1105. Weaving the wire 140 through the prongs 1105 in this way inhibits the wire 140 from sliding off the contact 130. In yet another example, the contact 130 includes a clamp and/or leaves that compress the wire 140 in place against the contact 130.

The contact 130 defines a contact surface 1115 positioned across from the prongs 1105. The contact 130 is generally a uniform surface that is configured to contact pins in a jack and/or socket. Typically, the pins in a socket are spring loaded. When the modular connector plug 105 plugs into the socket, the pins typically are biased to extend into the slots 225 and contact the contacts 130 on the contact surfaces 1115. The contact surface 1115 provides a surface for the pins to contact and electrically connect to the contact 130. In another example, the contact 130 includes a clamp and/or leaves that compress the pins in place against the contact 130.

In the illustrated example, the contact 130 includes flanges 1120 and defines divots 1125. The flanges 1120 extend outward from the rest of the contact 130. The flanges 1120 are configured to hold the contact 130 in place in the cover 120. The flanges 1120 prevent or inhibit movement of the contact 130 in one direction along the slots 225 of the cover 120. Similarly, the divots 1125 secure the contact 130 in place in the cover 120. The divots 1125 are shaped to receive a portion of the cover 120. In one example, the contact 130 is shaped to insert into the slot 225 from one end. Once the contact 130 is inserted to a certain extent into the slot 225, the divots 1125 secure the position of the contact 130 and prevent movement in any direction within the slot 225. The flanges 1120 and divots 1125 facilitate quick and reliable assembling of the cover 120. For example, the flanges 1120 and divots 1125 allow the contacts 130 to be inserted into the slots 225 and coupled to the cover 120 in a single motion. Further, the contact 130 is formed by cutting and bending a piece of material. For example, in the form of the plate 132, the contact 130 are formed by stamping a piece of copper and bending the prongs 1105. In the illustrated example, the contact 130 defines a plane along a lateral surface. The prongs 1105 are bent out of the plane. In one example, the outer-positioned prongs 1105 are bent toward one direction out of the plane. In such an example, the inner-positioned prong 1105 is bent in an opposite direction than the outer-positioned prongs 1105. Bending the prongs 1105 out of the plane of the contact 130 generally facilitates connecting the contact 130 to certain types of wires 140. For example, bending the prongs 1105 in different directions facilitates coupling the contact 130 to the wire 140 with a solid conductor 150. In another example, bending the prongs 1105 in this way is adapted to couple to both solid and stranded types of conductors 150. As should be appreciated, arranging and/or bending the prongs 1105 in different ways facilitates connecting different types of wires 140 to the contact 130.

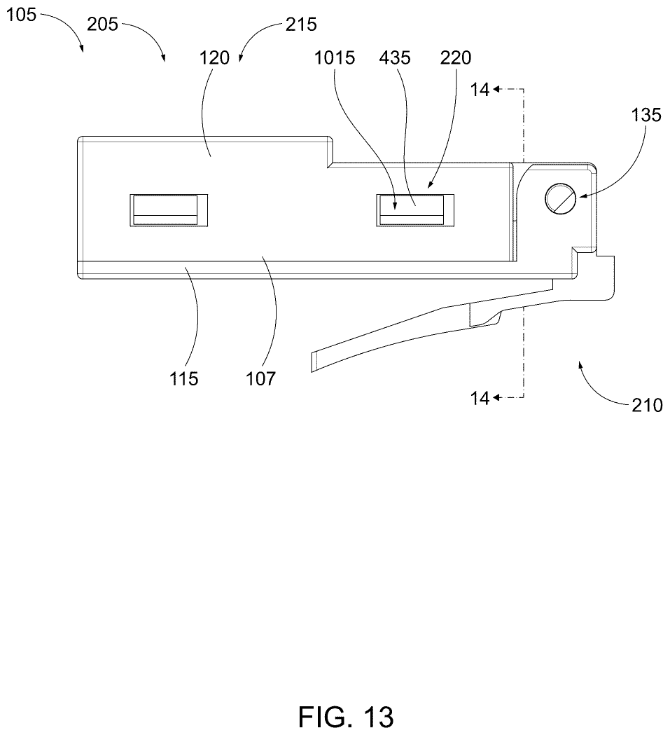

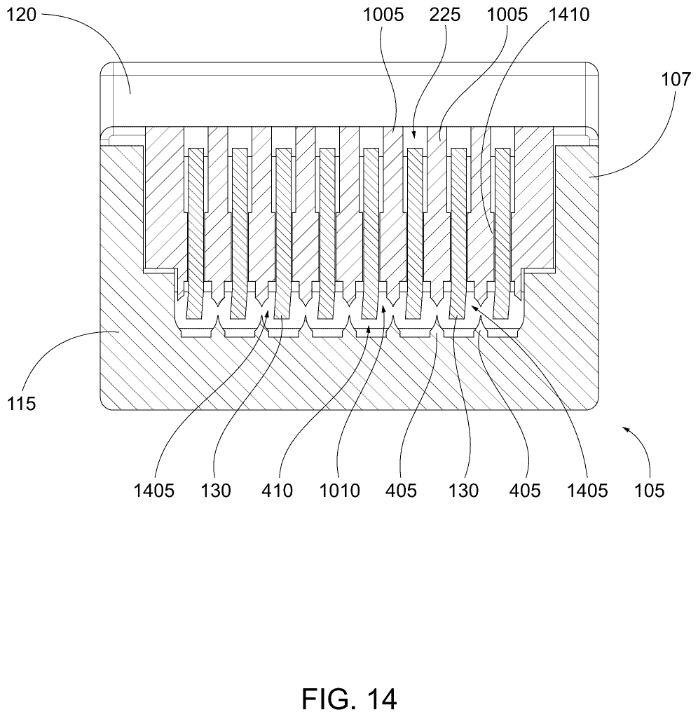

FIGS. 13 and 14 illustrate the modular connector plug 105 in the closed position 205. The snap-fit connection 220 couples the base 115 and the cover 120 when the modular connector plug 105 is in the closed position 205. As shown, the tab 435 is positioned in the tab opening 1015. The tab 435 secures the position of the base 115 against the cover 120. In the illustrated example, the tab opening 1015 extends further along the lateral axis 810 than the tab 435. The tab 435 and the tab opening 1015 secure the base 115 and cover 120 together in a rotational direction about the hinge 135. The hinge 135 further secures the base 115 and the cover 120 along the lateral axis 810. In an alternate embodiment, the modular connector plug 105 includes one or more fasteners and/or other types of joints that secure the base 115 and the cover 120 together. As should be appreciated, in other versions, one or more tabs 435 are positioned on the cover 120 and/or the cover walls 1012 are positioned between the base walls 425.

Referring to FIG. 14, the modular connector plug 105 defines one or more channels 1405 between the base 115 and the cover 120. The spacers 405 and dividers 1005 each define a portion of the channels 1405. The channels 1405 generally include the wire grooves 410 and the contact grooves 1010. When the modular connector plug 105 is in the closed position 205, each wire groove 410 and each contact groove 1010 together form one channel 1405 as a single larger space. The channel 1405 is configured to receive the wire 140. As illustrated, the contacts 130 extend into the channels 1405. When the wires 140 are positioned in the channels 1405, the contacts 130 extend partially within the wires 140. In one example, the contacts 130 are configured to extend at least half of the way through the wires 140. In another example, the contacts 130 are configured to extend fully through the wires 140.

The dividers 1005 include pads 1410. The pads 1410 typically contact the contacts 130. The pads 1410 inhibit or prevent movement of the contacts 130 along the lateral axis 810 within the slots 225. In one example, the pads 1410 compress the contacts 130 to secure the position of the contacts 130 within the slots 225. The slots 225 are integrally formed with the dividers 1005. In an alternate example, the pads 1410 are formed from a different material than the rest of the divider 1005 and/or cover 120, such as a cushioning material.

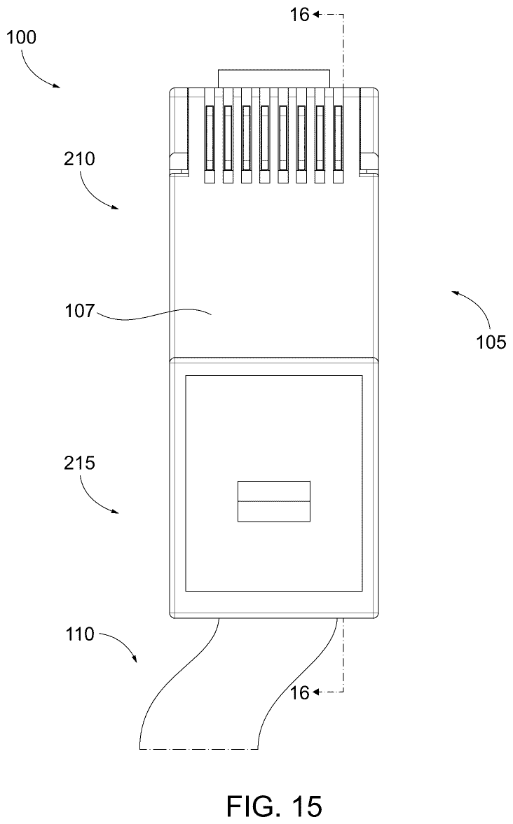

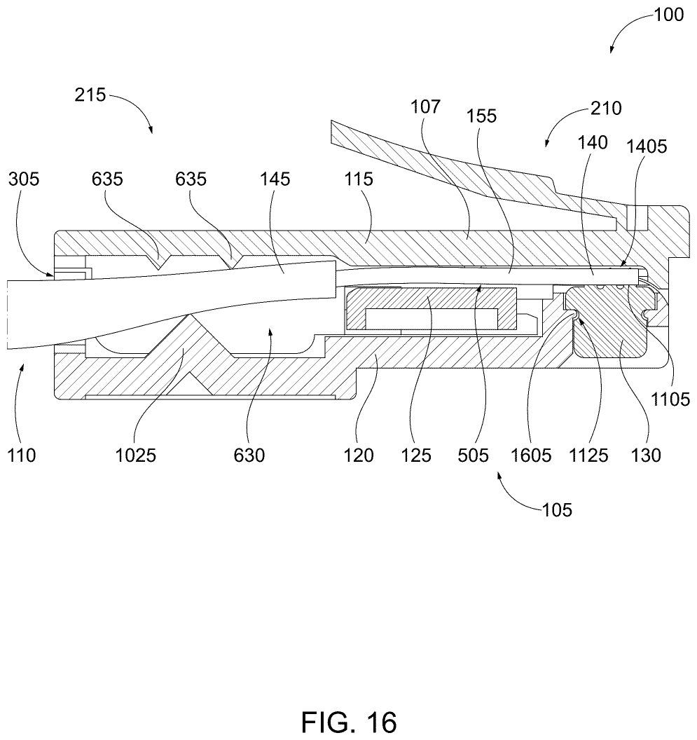

FIGS. 15 and 16 illustrate the system 100 with the modular connector plug 105 coupled to the cable 110. As illustrated, the cable 110 is positioned within the modular connector plug 105 through the cable opening 305. The sheath 145 generally extends only within the cavity 630 between the base 115 and the cover 120. The base ridges 635 and cover ridge 1025 contact and compress the sheath 145 within the stopper 605. By contacting the sheath 145, the base ridges 635 and cover ridge 1025 secure the cable 110 within the modular connector plug 105 and provide strain relief for the cable 110. In one example, the base ridges 635 and cover ridge 1025 guide the cable 110 to bend within the cavity 630. In an alternate example, the modular connector plug 105 includes a lever rather than the base ridges 635 and/or cover ridge 1025. In such an example, the lever is rotatable and configured to secure the cable 110 within the modular connector plug 105. For instance, the lever is positioned on the cover 120 at the receptacle 215 and is configured to press the sheath 145 against the base 115.

The wires 140 extend between the base 115 and the restraint 125. In one example, the sheath 145 is too large to fit through the gap 505. The restraint 125 and the base 115 generally compress the wire 140 within the gap 505 to secure the position of the wire 140. The wires 140 then extend into the channels 1405. The contacts 130 contact the wires 140 within the channels 1405. Typically, the prongs 1105 pierce into the insulators 155 to secure the wires 140 against the contacts 130. In the illustrated example, the prongs 1105 extend fully through the wire 140, including the conductor 150 and the insulator 155. When a user rotates the cover 120 toward the base 115, such as from the open position 905 as shown in FIG. 9, the cover 120 presses the contacts 130 into the wires 140. With the cover 120 pivotally coupled to the base 115, the cover 120 with the contact 130 acts as a class 2 lever in which the contacts 130 and the wires 140 are crimped together in a toolless manner. The base ridges 635 and the cover ridge 1025 further crimp the cable 110. By rotating the cover 120 in this way, the modular connector plug 105 allows a user to secure the cable 110 within the modular connector plug 105 using a single motion. Further, the modular connector plug 105 reliably electrically connects the contacts 130 to the conductors 150 in the wires 140 using the same single motion. The contacts 130 typically extend through the insulator 155 and partially into the conductor 150 to electrically connect to the conductor 150. In another example, the insulator 155 is stripped from the conductor 150 and the contact 130 directly presses into and contacts the conductor 150 without piercing the insulator 155.

As illustrated, the cover 120 includes one or more braces 1605. The braces 1605 are positioned within the slots 225. The braces 1605 extend into the divots 1125 on the contacts 130. The interaction between the braces 1605 and divots 1125 secures the contact 130 in place within the slot 225. In the illustrated example, the braces 1605 and the divots 1125 are round. The round shape facilitates pushing the contact 130 into the slot 225. The braces 1605 and divots 1125 form a snap-fit joint between the contact 130 and the cover 120. In one example, the cover 120 receives the contact 130 in the slot 225 at one end. The braces 1605 and divots 1125 prevent movement of the contact 130 in the slot 225 at a certain point and secure the position of the contact 130 in the slot 225. Securing the contacts 130 in the cover 120 in this way allows the contacts 130 to push into the wires 140 with sufficient force to pierce the wires 140. In one example, the modular connector plug 105 supports the contacts 130 to pierce through the insulation and the conductive portions of the wires 140. By piercing fully through the conductive portion of the wire 140, the prongs 1105 contact the wire 140 across a greater surface area than just contacting the wire 140 at the edges 1110 of the prongs 1105. The increased surface area supports a low impedance electrical connection between the wire 140 and the contact 130. The stable connection and low impedance between the wires 140 and the contacts 130 allow the modular connector plug 105 to support reliable electrical connections between the cable 110 and a socket. In this way, the modular connector plug 105 supports high speed data transfer between the cable 110 and the socket, such as at frequencies above 500 MHz.

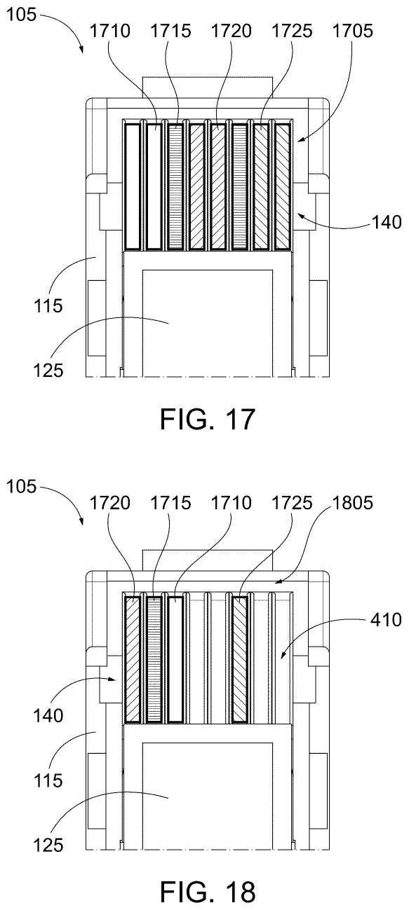

Referring to FIGS. 17 and 18, two arrangements of the wires 140 within the modular connector plug 105 are depicted. FIG. 17 illustrates the wires 140 arranged in a first conductor arrangement 1705. The wires 140 include a first wire 1710, a second wire 1715, a third wire 1720, and a fourth wire 1725. The arrangement of the wires 140 in the first conductor arrangement 1705 generally represents one type of pinout that the modular connector plug 105 supports, such as a T568A and/or T568B arrangement as examples. In the first conductor arrangement 1705, eight wires 140 are positioned in the modular connector plug 105. In the FIG. 17 example, each wire groove 410 is filled with one wire 140. By defining the wire grooves 410 side-by-side in a consistent way, the modular connector plug 105 facilitates arranging the wires 140 as desired. For example, the uniform arrangement of the wire grooves 410 enables a user to accurately position the wires 140 in the modular connector plug 105 according to a desired signal assignment and/or pinout.

FIG. 18 illustrates the wires 140 arranged in a second conductor arrangement 1805. In the illustrated example, the second conductor arrangement 1805 includes the same first wire 1710, second wire 1715, third wire 1720, and fourth wire 1725 as in the first conductor arrangement 1705. As shown, the positions of the first wire 1710, the second wire 1715, the third wire 1720, and the fourth wire 1725 are different in the second conductor arrangement 1805 than in the first conductor arrangement 1705. As noted, the modular connector plug 105 supports multiple arrangements of the wires 140. Allowing customizable positioning of the wires 140 enables a user to utilize a variety of pinouts and/or conductor arrangements. Additionally, the number of wires 140 in the second conductor arrangement 1805 is different than in the first conductor arrangement 1705. As illustrated, the second conductor arrangement 1805 only includes four wires 140, while the first conductor arrangement 1705 includes eight wires 140. The modular connector plug 105 supports using fewer wires 140, for example to use a different pinout, such as a 10BASE-T signal arrangement. Again, the modular connector plug 105 enables a user to toollessly connect the cable 110 to the modular connector plug 105 with the wires 140 in any desired arrangement. In this way, the modular connector plug 105 supports a high degree of customization while maintaining a standardized shape of the plug body 107. Customizing the arrangement and/or number of the wires 140 allows the modular connector plug 105 to be compatible with a variety of types of cables 110 and devices that utilize different wiring standards. In one example, only the position of the wires 140 is varied between the first conductor arrangement 1705 and the second conductor arrangement 1805. In another example, only the number of the wires 140 is varied between the first conductor arrangement 1705 and the second conductor arrangement 1805. As should be appreciated, the modular connector plug 105 supports various arrangements of the wires 140 that utilize various positions and/or numbers of the wires 140 within the modular connector plug 105.

In most, but not all cases, the wires 140 in the sheath 145 are twisted. Commonly, the wires 140 at the end of the cable 110 are generally straightened before insertion into the modular connector plug 105, but some residual twisting typically remains in at least some of the wires 140. Due to this residual twisting and the relatively small size of the wires 140, positioning the wires 140 within the wire grooves 410 of the modular connector plug 105 during installation can be quite difficult.

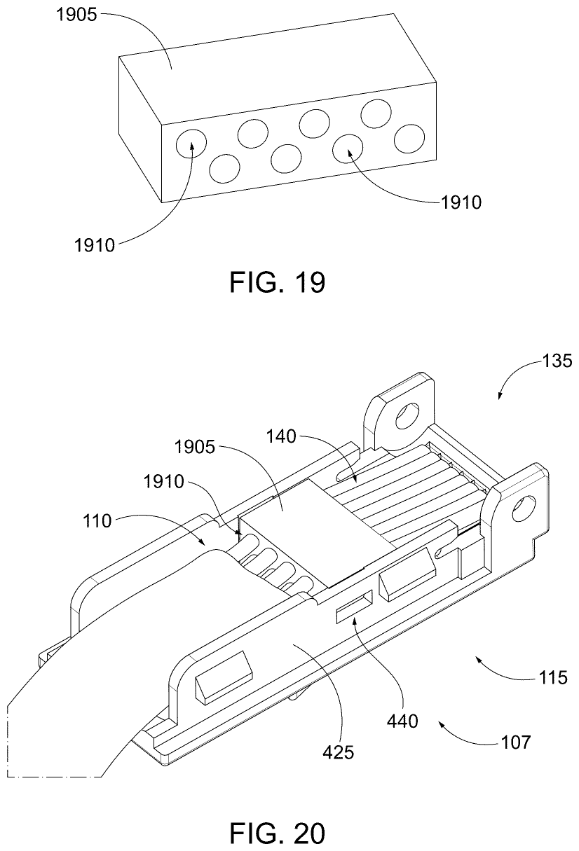

FIG. 19 shows one example of an insert 1905 that helps to hold the wires 140 in proper alignment during installation in the modular connector plug 105. However, as should be recognized from the other illustrated examples, the modular connector plug 105 in other variations does not include the insert 1905. In one version, the insert 1905 is a separate component from the modular connector plug 105. In one form, the wires 140 are first inserted into the insert 1905, and the insert 1905 with the wires 140 is then inserted into the modular connector plug 105. The insert 1905 in another form is first inserted into the plug body 107 of the modular connector plug 105, and then the wires 140 are inserted into the insert 1905. In another version, the insert 1905 is integrated a part of the modular connector plug 105. The insert 1905 can for example integrally formed in the modular connector plug 105 or connected to the modular connector plug 105.

The insert 1905 in one form is generally made of a rigid and insulative material, such as plastic. In one example, the insert 1905 is formed through injection molding. The insert 1905 is configured to align the wires 140 and maintain the position of the wires 140 within the plug body 107. As illustrated, the insert 1905 defines multiple wire holes 1910. The wire holes 1910 generally extend fully through the insert 1905 in a longitudinal direction through opposite sides of the insert 1905. By extending through the insert 1905, the wire holes 1910 allow the wires 140 to pass through the insert 1905. The wire holes 1910 allow a user to slide the wires 140 through the insert 1905. For example, a user may slide the wires 140 through the insert 1905 and then position the insert 1905 and the wires 140 within the plug body 107. In one example, the wire holes 1910 are sized within a low tolerance of the size of the wires 140. The low tolerance supports the wire holes 1910 to retain the wires 140 after a user has slid the wires 140 in the wire holes 1910. Instead of the wire holes 1910, the insert 1905 in other examples can include other types of openings or structures for holding the wires 140 in place. For instance, the insert 1905 in other forms includes slots that act as clips to hold the wires 140 in place. In one form, the contacts 130 penetrate into the portion of the wires 140 that are located in the slots when the modular connector plug 105 is closed.

In the illustrated example, the insert 1905 defines eight wire holes 1910. The wire holes 1910 are arranged in two rows. In another example, the insert 1905 defines a different number of wire holes 1910, such as four, six, ten, and/or another number. Typically, the insert 1905 defines the same number of wire holes 1910 as the number of conductors the modular connector plug 105 supports. In yet another example, the wire holes 1910 are positioned in a single row. The wire holes 1910 are generally spaced in the same way in a lateral direction as the wire grooves 410 on the base 115.

As shown in FIG. 20, the insert 1905 is configured to couple to the plug body 107. In one example, the insert 1905 is configured to couple to the base 115. The insert 1905 generally nests between the base walls 425 when coupling to the base 115. The insert 1905 couples to the base 115 through the snap-fit connection 440, through a friction fit, and/or in another way. After a user positions the wires 140 through the insert 1905, the user may position the insert 1905 within the plug body 107. When a user positions the insert 1905 and wires 140 in the plug body 107, the insert 1905 aligns the wires 140 with the wire grooves 410. Aligning the wires 140 this way also aligns the wires 140 with the contacts 130 on the cover 120. By aligning the wires 140 and the contacts 130, the insert 1905 supports the modular connector plug 105 to reliably crimp and couple to the wires 140.

In one example, the modular connector plug 105 includes the insert 1905 in place of the restraint 125. In another example, the modular connector plug 105 includes both the restraint 125 and the insert 1905. For instance, the insert 1905 couples to the base 115 where the spacers 405 and the wire grooves 410 are positioned. In such an example, the restraint 125 couples to the insert 1905 as shown in FIG. 9. In the illustrated example, the insert 1905 is spaced away from the hinge 135 so as to avoid obstructing the contacts 130. The wires 140 extend past the insert 1905 to a certain extent, such as one-eighth of an inch (3.175 mm). The length of the wires 140 that extends past the insert 1905 allows the contacts 130 to penetrate into the wires 140. In an alternate example, the insert 1905 is positioned near the hinge 135 and in the path of the contacts 130 as the modular connector plug 105 closes. In such an example, the insert 1905 defines one or more slots that allow the contacts 130 to penetrate into the wires 140 when closing the modular connector plug 105.

### GLOSSARY OF TERMS

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“And/Or” generally refers to a grammatical conjunction indicating that one or more of the cases it connects may occur. For instance, it can indicate that either or both of the two stated cases can occur. In general, “and/or” includes any combination of the listed collection. For example, “X, Y, and/or Z” encompasses: any one letter individually (e.g., {X}, {Y}, {Z}); any combination of two of the letters (e.g., {X, Y}, {X, Z}, {Y, Z}); and all three letters (e.g., {X, Y, Z}). Such combinations may include other unlisted elements as well.

“Cable” generally refers to one or more elongated strands of material that may be used to carry electromagnetic or electrical energy. A metallic or other electrically conductive material may be used to carry electric current. In another example, strands of glass, acrylic, or other substantially transparent material may be included in a cable for carrying light such as in a fiber-optic cable. A cable may include connectors at each end of the elongated strands for connecting to other cables to provide additional length. A cable is generally synonymous with a node in an electrical circuit and provides connectivity between elements in a circuit but does not include circuit elements. Any voltage drop across a cable is therefore a function of the overall resistance of the material used. A cable may include a sheath or layer surrounding the cable with electrically non-conductive material to electrically insulate the cable from inadvertently electrically connecting with other conductive material adjacent the cable. A cable may include multiple individual component cables, wires, or strands, each with, or without, a non-conductive sheathing. A cable may also include a non-conductive sheath or layer around the conductive material, as well as one or more layers of conductive shielding material around the non-conductive sheath to capture stray electromagnetic energy that may be transmitted by electromagnet signals traveling along the conductive material of the cable, and to insulate the cable from stray electromagnetic energy that may be present in the environment the cable is passing through. Examples of cables include twisted pair cable, coaxial cable, “twin-lead”, fiber-optic cable, hybrid optical and electrical cable, ribbon cables with multiple side-by-side wires, and the like.

“Cavity” generally refers to an empty space in a solid object. The cavity can be completely or partially surrounded by the solid object. For example, the cavity can be opened to the surrounding environment.

“Channel” generally refers to a long, narrow groove in a surface of an object.

“Conductor” or “Conductive Material” generally refers to a material and/or object that allows the free flow of an electrical charge in one or more directions such that relatively significant electric currents will flow through the material under the influence of an electric field under normal operating conditions. By way of non-limiting examples, conductors include materials having low resistivity, such as most metals (e.g., copper, gold, aluminum, etc.), graphite, and conductive polymers.

“Crimping” generally refers to a process of mechanically joining two materials, typically metal pieces and/or wire, by deforming one or both pieces to create a tight hold. The area of the pieces where the deformation occurs is typically called a “crimp”. One type of crimp is an electrical crimp. An electrical crimp is a type of solderless electrical connection that uses physical pressure to join contacts. For electrical crimps, crimp connectors are usually used to terminate wire. In one example use case, stripped wire, which is often stranded wire, is inserted through an opening of a connector, and a crimper tool is used to tightly squeeze the opening against the wire.

“Edge” generally refers to a border where an object or area begins or ends. The edge is typically in the form of a line or line segment that is at the intersection of two plane faces or of two planes of an object or space.

“Electrical Connection” generally refers to a connection between two objects that allows a flow of electric current and/or electric signals.

“Female” generally refers to a structure that connects to another structure that includes hollow portions for receiving portions of a corresponding male connector.

A “Friction Fit” or “Interference Fit” or “Pressed Fit” generally refers to a type of coupling between two parts. Typically, the two parts fit tightly against each other. One or more segments of the parts are configured to interact. In some examples, one part defines a hole and/or opening configured to receive a portion of the other part. The tolerance between interacting segments of the parts is typically low, such as below 1 millimeter, 100 micrometers, 10 micrometers, and/or another width. Frictional force between the parts is configured to hold the parts together in a friction fit. In some cases, the parts are pressed together to create a friction fit. In another example, the parts can form a friction fit through expansion and/or contraction of one of the parts, such as due to temperature changes and/or other deformation. A friction fit can be reversible and allow the parts to be repeatedly coupled and decoupled, or the friction fit can permanently couple the two parts.

“Gap” generally refers to a space between objects, surfaces, or points.

“Hinge” generally refers to a mechanical bearing or other device that connects at least two solid objects so as to allow only an angle of rotation between the objects. In one example, the objects connected by the hinge can rotate relative to each other about a fixed axis of rotation such that all other relative translations and/or rotations are prevented to provide one degree of freedom. In other examples, the hinge can provide multiple degrees of freedom. For instance, a living hinge, which is made of flexible material like plastic, can provide multiple axes of rotational freedom. In one form, the hinge includes a leaf with a knuckle that receives a pin. Some examples of hinge types include spring hinges, barrel hinges, pivot hinges, butt-mortise hinges, case hinges, piano hinges, concealed hinges, butterfly hinges, flag hinges, strap hinges, H-hinges, counter-flap hinges, self-closing hinges, friction hinges, double action hinges, and crank hinges, to name just a few.

“Insulator” or “Insulative Material” generally refers to a material and/or object whose internal electric charges do not flow freely such that very little electric current will flow through the material under the influence of an electric field under normal operating conditions. By way of non-limiting examples, insulator materials include materials having high resistivity, such as glass, paper, ceramics, rubber, and plastics.

“Lateral” generally refers to being situated on, directed toward, or coming from the side.

“Lever” generally refers to a simple machine including a beam, rod, or other structure pivoted at a fulcrum, such as a hinge. In one form, the lever is a rigid body capable of rotating on a point on itself. Levers can be generally categorized into three types of classes based on the location of fulcrum, load, and/or effort. In a class 1 type of lever, the fulcrum is located in the middle such that the effort is applied on one side of the fulcrum and the resistance or load on the other side. For class 1 type levers, the mechanical advantage may be greater than, less than, or equal to 1. Some non-limiting examples of class 1 type levers include seesaws, crowbars, and a pair of scissors. In a class 2 type of lever, which is sometimes referred to as a force multiplier lever, the resistance or load is located generally near the middle of the lever such that the effort is applied on one side of the resistance and the fulcrum is located on the other side. For class 2 type levers, the load arm is smaller than the effort arm, and the mechanical advantage is typically greater than 1. Some non-limiting examples of class 2 type levers include wheelbarrows, nutcrackers, bottle openers, and automobile brake pedals. In a class 3 type lever, which is sometimes referred to as a speed multiplier lever, the effort is generally located near the middle of the lever such that the resistance or load is on one side of the effort and the fulcrum is located on the other side. For class 3 type levers, the effort arm is smaller than the load arm, and the mechanical advantage is typically less than 1. Some non-limiting examples of class 3 type levers include a pair of tweezers and the human mandible.

“Longitudinal” generally refers to the length or lengthwise dimension of an object, rather than across.

“Male” generally refers to a structure that connects to another structure that includes portions that fill or fit inside the hollow portion of a corresponding female connector.

“Modular Connector” or “Registered Jack (RJ) Connector” generally refers to a device that makes electrical and mechanical connections between multiple conductors and which utilizes standard connector shapes and/or sizes but supports a variety of conductor arrangements and/or pinouts. In many cases, modular connectors utilize a compact form and relatively simple shape, such as a generally rectangular or box shape. The modular connector typically includes a plug and a jack/socket that receives the plug. In many, but not all cases, the plug attaches to a wire, cord, and/or cable, and the socket is attached to a circuit board, busbars, wires, and/or other conductors in an electronic device or appliance. For instance, the modular connector can be used to connect cables and/or wires to computer networking devices, telecommunication equipment, and/or audio devices, through standard signals and wiring. The plug includes two or more contacts made of an electrically conductive material, like copper and/or aluminum. The socket likewise has a series of contacts arranged to touch and electrically connect to the contacts in the plug. Typically, the contacts are arranged side-by-side in a uniform layout so as to simplify the constructions of the plug and the socket. Further, the plug includes a plug body made of an insulative material to electrically isolate the contacts from one another. The plug body typically has a rectangular cross-section or is box-shaped, and the socket receives the plug body in a conjugately shaped cavity. The size of the plug body is typically comparable to the size of the cable and not significantly disproportionate to the cable. Modular connector plugs typically facilitate attaching wires to the contacts due to the uniform positioning of the contacts and the simple rectangular shape. A user can attach wires in a variety of positions within the modular connector. Modular connectors are usually designated by two numbers that represent the maximum contact positions (P) and the number of installed contacts (C). For instance, some common position and contact arrangements include 4P4C, 6P4C, 6P6C, 8P8C, and 10P10C, to name just a few. Modular connectors are produced in four standard sizes, a four-position size, a six-position size, an eight-position size, and a ten-position size. The number of contacts used in the modular connector, the wiring, and signals for each contact can vary within even the same position size, depending on the standard or application used. In other words, the contact assignments or pinouts can vary based on the application or standard. The specifications or standards can specify the pin outs, maximum current ratings, maximum operating voltage ratings, contact size, number of contacts, and mounting types. Some common types of modular connecter standards include the RJ10, RJ11, RJ 12, DEC MMP/MMJ, RJ13, RJ14, RJ21, RJ22, RJ25, RJ45, RJ48, and RJ50 type modular connector standards, to name just a few examples. The modular connectors can further incorporate shielding, such as integrated magnetics or other shielding, to reduce electromagnetic interference. In most cases, the modular connectors include a latch mechanism that secures the physical connection between the plug and the socket. In one example, the latch mechanism includes a tab on the plug that locks against a ridge in the socket so that the plug cannot be removed without disengaging the tab by pressing the tab against the body of the plug. In most cases, but not all cases, the tab and the body of the plug is covered with a boot that prevents to the tab from hooking cables or other objects that can excessively bend the tab. Keying structures can further be used, such as via latch tab orientation, so that the plug is only able to be inserted in one direction to avoid improper wiring. Generally, modular connectors provide strain relief on the cable and/or wire by securing insulation and/or sheathing that covers the conductors. In some case, the modular connector further includes displays or indicators, such as light emitting diodes (LEDs), to indicate connection status.

“Notch” generally refers to an indentation, cut, groove, channel, and/or incision on an edge or surface. In some non-limiting examples, the notch includes a V-shaped or U-shaped indentation carved, scratched, etched, stamped, and/or otherwise formed in the edge or surface. The notch can have a uniform shape or a non-uniform shape.

“Opening” generally refers to a space or slot that something can pass through and/or be placed into.

“Pin” or “Peg” generally refers to an elongated piece of material such as wood, metal, plastic and/or other material. Typically (but not always), the pin is tapered at one or both ends, but the pin can be shaped differently in other examples. For example, the ends of the pin can be flattened, widened, and/or bent in order to retain the pin. Pins can be used for any number of purposes. For example, the pin can be used in machines to couple components together or otherwise act as an interface between components. Pins can also be used for holding things together, hanging things on, and/or marking a position. Normally, but not always, the pin is a small, usually cylindrical piece. In certain cases, the pin is pointed and/or a tapered piece used to pin down, fasten things together, and/or designed to fit into holes. In other examples, the pin can have a polyhedral shape, such as with a rectangular or triangular cross-sectional shape, or an irregular shape.

“Plug” generally refers to device that electrically connects a wire, cord, and/or cable to and inserts into a socket and/or jack. In other words, a plug is typically a male connector that interfaces with a female connector to make an electrical connection. Plugs generally include one or more electrical contacts, such as electrically conductive pads, pins, leaves, and/or plates as examples. In some cases, the contacts in a plug are recessed within the plug, and contacts from a socket insert into the plug when plugging into the socket. Plugs often, but not always, come in a standardized shape, such as USB-A, USB-B, USB-C, HDMI, VGA, 3.5 mm audio, Ethernet, landline telephone, and/or various standardized power plugs to name a few. Similarly, the contacts in a plug are generally arranged according to a standardized pinout. For example, Ethernet cables typically include a Registered Jack (RJ) 45 plug to support network connections between computers, modems, routers, network switches, and/or other network devices. As another example, telephone cables generally include an RJ11, RJ14, and/or RJ25 plug to connect telephones and/or telephone network devices. Standardized plug shapes and pinouts generally match those of the standard sockets to ensure proper connection between the contacts in the plug and the socket. Further, the plug typically mechanically connects to the socket when the plug is inserted, such as through a clip, tab, and/or another mechanism. In some cases, the plug includes a latch tab and/or a keying mechanism to ensure a plug can only be inserted in one orientation.

“Recessing” means here a space, recess or divot in an object which is set back or indented from other portions or surfaces of the object. Recessing may have various shapes or forms.

“Snap-Fit Connector” or “Snap-Fit Connection” generally refers to a type of attachment device including at least two parts, with at least one of which being flexible, that are interlocked with one another by pushing the parts together. The term “Snap-Fit Connector” may refer to just one of the parts, such as either the protruding or mating part, or both of the parts when joined together. Typically, but not always, the snap-fit connector includes a protrusion of one part, such as a hook, stud, and/or bead, that is deflected briefly during the joining operation and catches in a depression and/or undercut in the mating part. After the parts are joined, the flexible snap-fit parts return to a stress-free condition. The resulting joint may be separable or inseparable depending on the shape of the undercut. The force required to separate the components can vary depending on the design. By way of non-limiting examples, the flexible parts are made of a flexible material such as plastic, metal, and/or carbon fiber composite materials. The snap-fit connectors can include cantilever, torsional, and/or annular type snap-fit connectors. In the annular snap-fit type connector, the connector utilizes a hoop-strain type part to hold the other part in place. In one form, the hoop-strain part is made of an elastic material and has an expandable circumference. In one example, the elastic hoop-strain part is pushed onto a more rigid part so as to secure the two together. Cantilever snap-fit type connectors can form permanent type connections or can be temporary such that the parts can be connected and disconnected multiple times. A multiple use type snap-fit connector typically, but not always, has a lever or pin that is pushed in order to release the snap-fit connection. For a torsional snap-fit connector, protruding edges of one part are pushed away from the target insertion area, and the other part then slides in between the protruding edges until a desired distance is reached. Once the desired distance is reached, the edges are then released such that the part is held in place.

“Socket” or “Jack” generally refers to a receptacle, slot, and/or opening that electrically connects to a plug when the plug is inserted. In other words, a socket is typically a female connector that interfaces with a male connector to make an electrical connection. Many devices, such as computers, telephones, display devices, networking devices, audio devices, and/or other types of devices, include sockets to support electrical connections between each other. Sometimes sockets are attached to a wall and/or another structure to support electrical connections to a network, audio/visual system, and/or power source as examples. Sockets generally include one or more electrical contacts, such as electrically conductive pads, pins, leaves, and/or plates as examples. In some cases, the contacts in a socket extend outward and insert into the plug as the plug inserts into the socket. Sockets often, but not always, come in a standardized shape, such as USB-A, USB-B, USB-C, HDMI, VGA, 3.5 mm audio, Ethernet, landline telephone, and/or various standardized power plugs to name a few. Similarly, the contacts in a socket are generally arranged according to a standardized pinout. For example, many computers, modems, routers, network switches, and/or other network devices include a Registered Jack (RJ) 45 jack to support connections via Ethernet. As another example, many telephones and/or telephone network devices include an RJ11, RJ14, and/or RJ25 jack to connect over a telephone line. Further, the socket typically mechanically connects to the plug when the plug is inserted, such as through a clip, tab, and/or another mechanism. In some cases, the socket defines a notch and/or recess that receives a latch tab on the plug. Some sockets utilize such a notch and/or include other keying mechanisms to ensure a plug can only be inserted in one orientation.

“Surface” generally refers to an outermost or uppermost layer of a physical object or space. The surface is typically a portion or region of the object that can first be perceived by an observer using the senses of sight and touch. The surface is usually the portion with which other materials first interact.

“Tab” generally refers to a projection, flap, or strip of material that extends from an object or structure.

“Terminal” generally refers to a plug, socket or other connection (male, female, mixed, hermaphroditic, or otherwise) for mechanically and electrically connecting two or more wires or other conductors.

“Termination” generally refers to the process or the end result of preparing a wire, cable, or another type of conductor to electrically connect to a different conductor. Termination typically, but not always, involves attaching a conductor to a connector and/or a terminal, such as a plug, socket, ring terminal, and/or alligator clip as examples. In most, but not all, cases, wires and/or other conductors are cut, shortened, stripped, and/or modified another way during termination. For instance, insulation is sometimes stripped from the conductor in a wire and/or cable to facilitate making an electrical connection to the conductor. Typically, the wire and/or other type of conductor is soldered, crimped, pierced, clamped, and/or compressed in place within a connector and/or terminal. In one example, a wire is terminated by compressing a stripped wire against an electrical contact in a connector. In another example, a wire does not need to be stripped and is terminated by piercing insulation with electrical contacts in a connector. Termination generally facilitates electrically connecting one conductor to another conductor, such as a busbar, circuit board, and/or another wire as some examples. When termination involves connecting one or more conductors to a plug, the termination generally supports electrical connections between the conductors and a socket, jack, port, and/or outlet. When a termination involves connecting one or more conductors to a socket, the termination generally supports electrical connections between the conductors and a plug. In some cases, terminations further include securing insulation and/or sheathing on a wire or cable to a connector to provide strain relief for the conductors.

“Toolless” generally refers to an activity not having and/or requiring tools in order to perform the activity. Typically, the act can be performed manually by an individual.

“Wall” means here a structure that forms a solid surface. It may be a portion of a house, room, or otherwise. A wall may be planar or multiplanar and may be constructed of any of a variety of materials, including, but not limited to metal, concrete, wood, or plastic.

“Wire” generally refers to elongated electrically conductive metal. This includes an individual strand, multiple strands (twisted, braided and/or not), traces, strips and other cross-sectional geometries. In some examples, wire is uninsulated wire, such as bare wire without a coating and/or plating. In other examples, wire is insulated wire with a coating of non-conductive material surrounding the wire. In some examples, insulated wire is coated with plastic, fluoropolymer, and/or rubber materials.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### REFERENCE NUMBERS

100 system
105 modular connector plug
107 plug body
110 cable
115 base
120 cover
125 restraint
130 contact
132 plate
135 hinge
140 wire
145 sheath
150 conductor
155 insulator
205 closed position
210 head
215 receptacle
220 snap-fit connection
225 slot
230 divot
305 cable opening
310 latching mechanism
312 latch tab
315 pivot pin
320 leaf
325 pin opening
330 ledge
335 rim
340 notch
405 spacer
410 wire groove
415 cam surface
420 chamfered edge
425 base wall
430 lip
435 tab
440 snap-fit connection
445 peg
450 peg slot
505 gap
510 panel
605 stopper
610 tip
615 platform
620 flange opening
625 track
630 cavity
635 base ridge
640 hump
645 ledge
705 flange
710 guide surface
805 longitudinal axis
810 lateral axis
905 open position
1005 divider
1010 contact groove
1012 cover wall
1015 tab opening
1020 recess
1025 cover ridge
1030 leaf slot
1035 fillet
1040 notch
1105 prong
1110 edge
1115 contact surface
1120 flange
1125 divot
1405 channel
1410 pad
1605 brace
1705 first conductor arrangement
1710 first wire
1715 second wire
1720 third wire
1725 fourth wire
1805 second conductor arrangement
1905 insert
1910 wire hole

What is claimed is:

1. A system, comprising:
a modular connector plug including a plug body and contacts held by the plug body; and
wherein the plug body is configured to crimp wires with the contacts in a toolless manner.

2. The system of claim 1, wherein the plug body has a base and a cover coupled to the base in a pivotal manner.

3. The system of claim 2, wherein:
the base is configured to receive a cable;
the base aligns each wire with one contact as the cable is positioned in the plug body; and
the contacts are positioned in the cover.

4. The system of claim 2, wherein:
the base includes spacers;
the spacers define one or more wire grooves; and
the spacers configured to align each wire in a separate wire groove.

5. The system of claim 2, wherein:
the modular connector plug is configured to clamp to a cable;
the cover and the base include ridges;
the ridges are configured to compress the cable within the plug body; and
the ridges provide strain relief for the wires.

6. The system of claim 2, wherein:
the plug body has one or more pivot pins that secure the cover to the base in the pivotal manner; and
the contacts are positioned proximal to the pivot pins to form a class 2 lever that promotes crimping between the wires and the contacts.

7. The system of claim 2, further comprising:
a restraint coupled to the base; and
wherein the restraint is configured to hold the wires against the base.

8. The system of claim 1, wherein:
the contact includes one or more prongs; and
the prongs are configured to stab the wire.

9. The system of claim 2, wherein:
the plug body is movable between an open position and a closed position;
the base includes spacers;
the cover includes one or more dividers;
the dividers and the spacers define channels when the connector is in the closed position;
the channels are configured to receive the wires; and
the contacts are configured to wedge into the wires within the channel.

10. A system, comprising:
a modular connector plug including;
a plug body made of an insulative material, the plug body including a base and a cover, wherein the base is coupled to the cover on one end, and
two or more contacts fixed to the plug body, wherein the contacts are made of an electrically conductive material; and
wherein the plug body is movable between an open position and a closed position;
wherein the base and the cover are fixed together in the closed position;
wherein the modular connector plug is configured to clamp to a cable; and
wherein the modular connector plug is in the form of a standardized plug shape.

11. The system of claim 10, wherein:
the base and the cover are coupled via a hinge; and
the base is free to rotate relative to the cover about the hinge.

12. The system of claim 10, wherein:
the base includes spacers; and
the spacers define one or more wire grooves.

13. The system of claim 11, wherein:
the plug body includes a snap-fit connection; and
the snap-fit connection fixes the cover to the base in the closed position.

14. The system of claim 13, wherein:
the base includes one or more tabs;
the cover defines one or more tab openings;
the tab openings retain the tabs when the modular connector plug is closed; and
the tabs secure the base against the cover.

15. The system of claim 11, wherein:
the base includes a leaf;
the leaf defines a pin opening;
the cover includes a pivot pin; and
the pivot pin is positioned in the pin opening.

16. The system of claim 10, further comprising a restraint coupled to the base; and wherein the base and the restraint define a gap.

17. The system of claim 16, wherein:
the restraint includes one or more flanges;
the base defines one or more flange openings;
the base defines tracks that extend toward the flange openings; and
the flanges are positioned in the flange openings.

18. The system of claim 16, wherein the restraint is configured to rotate relative to the base.

19. The system of claim 10, wherein:
the cover includes cover walls;
the base includes base walls; and
the base walls nest between the cover walls when the connector closes.

20. The system of claim 10, wherein:
the cover defines slots;
each contact is positioned in one slot;
the cover includes a brace;
the contact defines a divot; and
the brace secures the contact in the slot in the plug body.

21. The system of claim 10, further comprising:
a cable including one or more wires; and
an insert configured to align the wires in the modular connector plug.
